(19) United States
(12) Patent Application Publication
(10) Pub. No.: US 2025/0243029 A1
(43) Pub. Date: Jul. 31, 2025

(54) MEDIUM PROCESSING APPARATUS AND IMAGE FORMING SYSTEM INCORPORATING SAME

(71) Applicant: Ryo Suzuki, KANAGAWA (JP)

(72) Inventor: Ryo Suzuki, KANAGAWA (JP)

(73) Assignee: Ricoh Company, Ltd., Tokyo (JP)

(21) Appl. No.: 19/002,000

(22) Filed: Dec. 26, 2024

(30) Foreign Application Priority Data
Jan. 31, 2024 (JP) 2024-013685

(51) Int. Cl. B65H 37/04; B41J 3/44; G03G 15/00

(52) U.S. Cl. CPC B65H 37/04; B41J 3/44; G03G 15/6544; B65H 2301/5142; B65H 2301/51616; B65H 2406/41; B65H 2513/40; B65H 2801/27; G03G 2215/00936

(57) ABSTRACT

A medium processing apparatus includes a liquid applier and a post-processing device. The liquid applier applies liquid onto a medium. The post-processing device performs a process on a media bundle including the medium with the liquid applied by the liquid applier. The liquid applier includes a liquid application member, a liquid storage, a movement mechanism, and a compression support. The liquid application member has an end portion to contact with the medium to apply the liquid onto the medium. The liquid storage stores the liquid to be supplied to the liquid application member. The movement mechanism moves the liquid application member toward or away from the medium to bring the end portion into contact with the medium or separate the end portion from the medium as an approaching operation. The compression support compresses the liquid application member according to the approaching operation of the movement mechanism.

### CROSS-REFERENCE TO RELATED APPLICATION

This patent application is based on and claims priority pursuant to 35 U.S.C. § 119(a) to Japanese Patent Application No. 2024-013685, filed on Jan. 31, 2024, in the Japan Patent Office, the entire disclosure of which is hereby incorporated by reference herein.

### BACKGROUND

### Technical Field

Embodiments of the present disclosure relate to a medium processing apparatus and an image forming system incorporating the medium processing apparatus.

### Background Art

Various types of medium processing apparatuses are known that bind a sheet bundle of stacked sheet media. Such medium processing apparatuses employ binding processes including, for example, a “stapling process” for penetrating needle-shaped members (binding members) through a sheet bundle to bind the sheet bundle and a “crimping process” for performing pressure deformation on a portion of a sheet bundle to bind the sheet bundle.
Various post-processing apparatuses (medium processing apparatuses) disclose, in order to increase the number of sheets to be bound by increasing the binding force, a configuration in which the leading end portion of a liquid supply member that contains liquid in advance is brought to contact or separate from the crimp binding position of a medium (sheet), so that liquid is applied to each of media (sheets) to be stacked for binding.
As in the configuration disclosed as above, in a case where liquid is applied by bringing the leading end portion of a liquid supply member to contact or separate from the position at which the media (sheets) are crimped and bound, the leading end portion needs to contain liquid in advance. For example, a medium processing apparatus in the art discloses a configuration in which liquid is supplied from a liquid storage tank following the leading end portion by the capillary phenomenon.

As the height direction in which the liquid is sucked up by the capillary phenomenon increases and the area of a supply member (member for supplying liquid to the leading end portion) in contact with the liquid decreases, the speed (liquid supply speed) at which the liquid is supplied to the leading end portion decreases. For the above reasons, in the related art, it is difficult to solve the problem that the liquid application amount is not stable when the liquid level of the liquid storage tank becomes a certain water level or less.

### SUMMARY

Embodiments of the present disclosure described herein provide a novel medium processing apparatus including a liquid applier and a post-processing device. The liquid applier applies liquid onto a medium. The post-processing device performs a process on a media bundle including the medium with the liquid applied by the liquid applier. The liquid applier includes a liquid application member, a liquid storage, a movement mechanism, and a compression support. The liquid application member has an end portion to contact with the medium to apply the liquid onto the medium. The liquid storage stores the liquid to be supplied to the liquid application member. The movement mechanism moves the liquid application member toward or away from the medium to bring the end portion into contact with the medium or separate the end portion from the medium as an approaching operation.

The compression support compresses the liquid application member according to the approaching operation of the movement mechanism.

Further, embodiments of the present disclosure described herein provide an image forming system including an image forming apparatus to form an image on a medium, and the above-described medium processing apparatus to perform the process on multiple media including the medium having the image formed by the image forming apparatus.

### BRIEF DESCRIPTION OF THE SEVERAL VIEWS OF THE DRAWINGS

Exemplary embodiments of this disclosure will be described in detail based on the following figures, wherein:

FIG. 1 is a diagram illustrating an overall configuration of an image forming system according to an embodiment of the present disclosure;

FIG. 2 is a diagram illustrating an internal configuration of a post-processing apparatus included in the image forming system of FIG. 1;

FIG. 3 is a schematic diagram illustrating an edge binder according to an embodiment of the present disclosure, viewed from an upstream side in a conveyance direction;

FIG. 4 is a schematic diagram illustrating the edge binder of FIG. 3 as viewed from the side on which a liquid applier is disposed in a main scanning direction;

FIGS. 5A and 5B are schematic diagrams illustrating a configuration of a crimper according to an embodiment of the present disclosure;

FIG. 6 is a schematic diagram illustrating a staple binder according to an embodiment of the present disclosure, viewed from an upstream side in a conveyance direction;

FIG. 7 is a schematic diagram illustrating a staple binder as a modification of the staple binder of FIG. 6, viewed from the upstream side in the conveyance direction;

FIG. 8 is a diagram illustrating a hardware configuration of a control block for controlling an operation of a post-processing apparatus according to an embodiment of the present disclosure;

FIG. 9 is a diagram illustrating a configuration of a liquid applier according to a first embodiment of the present disclosure;

FIGS. 10A, 10B, and 10C are diagrams illustrating a change in the amount of liquid in a liquid storage tank in a dry state of a liquid supply member according to the first embodiment of the present disclosure;

FIG. 11A is a flowchart including the first half of a liquid supply determination process according to the first embodiment of the present disclosure;

FIG. 11B is a flowchart including the second half of the liquid supply determination process according to the first embodiment of the present disclosure;

FIGS. 12A and 12B are diagrams illustrating a typical example of the liquid application device according to the present embodiment;

FIGS. 13A and 13B are diagrams illustrating examples of a liquid supply operation executable in the liquid application device;

FIGS. 14A and 14B are diagrams illustrating examples of a liquid supply operation executable in the liquid application device;

FIG. 15 is a flowchart of a liquid supply process according to the first embodiment of the present disclosure;

FIG. 16 is a flowchart of a liquid supply process in connection to the liquid supply process of the flowchart of FIG. 15, according to the first embodiment of the present disclosure;

FIG. 17 is a flowchart of a liquid supply process in connection to the liquid supply process of the flowchart of FIG. 16, according to the first embodiment of the present disclosure;

FIG. 18 is a flowchart of a liquid supply process in connection to the liquid supply process of the flowchart of FIG. 16, according to the first embodiment of the present disclosure;

FIG. 19 is a flowchart of a liquid supply process in connection to the liquid supply process of the flowchart of FIG. 16, according to the first embodiment of the present disclosure;

FIGS. 20A and 20B are partial enlarged views of the liquid application device according to the first embodiment of the present disclosure;

FIG. 21 is a partial enlarged view of the liquid application device according to the first embodiment of the present disclosure;

FIGS. 22A, 22B and 22C are diagrams illustrating a liquid application device according to a second embodiment of the present disclosure;

FIG. 23 is a flowchart of a liquid supply process according to the second embodiment of the present disclosure;

FIG. 24 is a flowchart of a liquid supply process according to the second embodiment of the present disclosure;

FIG. 25 is a diagram illustrating the internal configuration of a post-processing apparatus according to another embodiment of the present disclosure;

FIGS. 26A, 26B, and 26C are diagrams each illustrating an internal tray of the post-processing apparatus of FIG. 25, viewed from the thickness direction of a sheet;

FIG. 27 is a schematic diagram illustrating a crimper of the post-processing apparatus of FIG. 25, viewed from the downstream side of the crimper in the conveyance direction of a sheet;

FIGS. 28A and 28B are schematic views of a liquid application device of the post-processing apparatus of FIG. 25, viewed from the thickness direction of a sheet;

FIGS. 29A, 29B and 29C are cross-sectional views of a liquid application unit of a liquid applier of the post-processing apparatus of FIG. 25, taken through XXV-XXV of FIG. 28A;

FIGS. 30A, 30B and 30C are cross-sectional views of the liquid application unit of the liquid applier of the post-processing apparatus of FIG. 25, taken along a line XXVI-XXVI of FIG. 28A;

FIG. 31 is a control block diagram illustrating a hardware configuration of the post-processing apparatus of FIG. 25 to control the operation of the post-processing apparatus;

FIG. 32 is a flowchart of post-processing performed by the post-processing apparatus of FIG. 25; and

FIG. 33 is a diagram illustrating an overall configuration of an image forming system according to a modification of the above embodiments of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. Identical reference numerals are assigned to identical or equivalent components and a description of those components may be simplified or omitted.

A description is given of an image forming system 1 according to an embodiment of the present disclosure, with reference to the drawings.

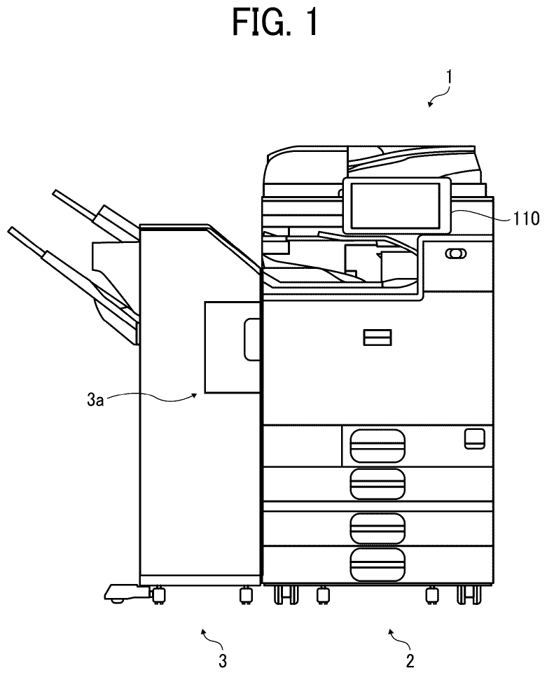

FIG. 1 is a diagram illustrating an overall configuration of the image forming system 1.

The image forming system 1 has a function of forming an image on a sheet P as a sheet medium and a function of performing a post-processing operation on the sheet P as a process after the image is formed on the sheet P. As illustrated in FIG. 1, the image forming system 1 includes an image forming apparatus 2 and a post-processing apparatus 3 serving as a medium processing apparatus according to an embodiment of the present disclosure. In the image forming system 1, the image forming apparatus 2 and the post-processing apparatus 3 operate in conjunction with each other.

The image forming apparatus 2 forms an image on the sheet P and outputs the sheet P bearing the image to the post-processing apparatus 3. The image forming apparatus 2 includes a sheet tray that accommodates the sheet P, a conveyor that conveys the sheet P accommodated in the sheet tray, and an image forming device that forms an image on the sheet P conveyed by the conveyor. The image forming device may be an inkjet image forming device that forms an image with ink or an electrophotographic image forming device that forms an image with toner. Since the image forming apparatus 2 has a typical configuration, a detailed description of the configuration and functions of the image forming apparatus 2 are omitted.

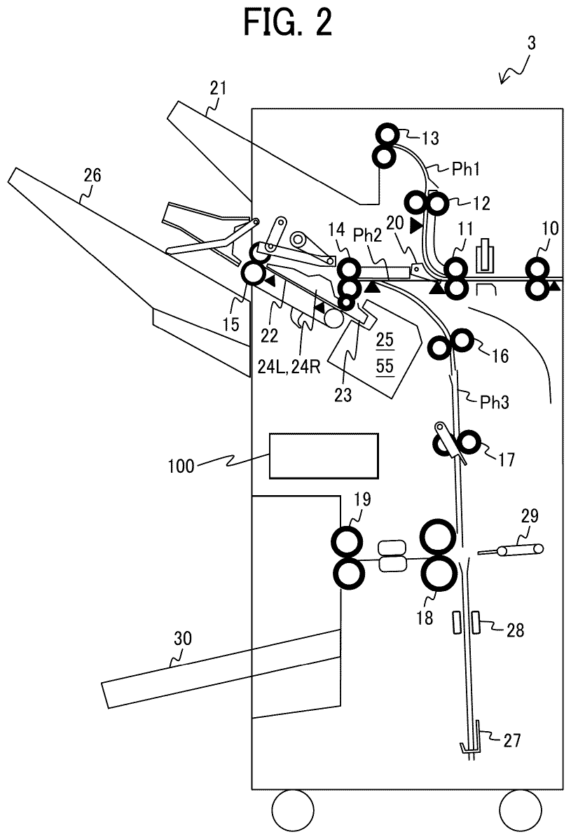

FIG. 2 is a diagram illustrating an internal configuration of the post-processing apparatus 3 included in the image forming system 1 of FIG. 1.

The post-processing apparatus 3 has a function that performs given post-processing on the sheet P on which an image is formed by the image forming apparatus 2. The post-processing according to the present embodiment is a binding process including a stapling process to bind a bundle of sheets P on each sheet of which an image is formed, and a crimp binding process to bind, without staples, the bundle of multiple sheets P. In the following description, the bundle of sheets may be referred to as a “sheet bundle Pb” as a bundle of media.

More specifically, the “crimp binding process” according to the present embodiment is a process called “crimp binding” of applying pressure to a binding position corresponding to a part of sheets P of a sheet bundle Pb to deform (press and deform) the binding position to bind the sheet bundle Pb. Examples of the binding process that can be executed by the post-processing apparatus 3 include edge binding and saddle binding. The edge binding is a process to bind an edge of the sheet bundle Pb. The saddle binding is a process to bind the center of the sheet bundle Pb.

The post-processing apparatus 3 includes conveyance roller pairs 10 to 19 as conveyors and a switching member 20. The conveyance roller pairs 10 to 19 convey, inside the post-processing apparatus 3, the sheet P supplied from the image forming apparatus 2. More specifically, the conveyance roller pairs 10 to 13 convey the sheet P along a first conveyance path Ph1. The conveyance roller pairs 14 and 15 convey the sheet P along a second conveyance path Ph2. The conveyance roller pairs 16 to 19 convey the sheet P along a third conveyance path Ph3.

The first conveyance path Ph1 is a path extending to an ejection tray 21 from a sheet supplying port through which the sheet P is supplied from the image forming apparatus 2. The second conveyance path Ph2 is a path branching from the first conveyance path Ph1 between the conveyance roller pairs 11 and 14 in a conveyance direction and extending to an ejection tray 26 via an internal tray 22. The third conveyance path Ph3 is a path branching from the first conveyance path Ph1 between the conveyance roller pairs 11 and 14 in the conveyance direction and extending to an ejection tray 30.

The switching members 20 are disposed at a branching position of the first conveyance path Ph1 and the second conveyance path Ph2.

Each of the switching members 20 can change the position between a first position and a second position. The switching member 20 at the first position guides the sheet P to be ejected to the ejection tray 21 through the first conveyance path Ph1. The switching members 20 at the second position guides the sheet P conveyed through the first conveyance path Ph1 to the second conveyance path Ph2. When a trailing end of the sheet P entering the second conveyance path Ph2 passes through the conveyance roller pair 11, the conveyance roller pair 14 is rotated in reverse to guide the sheet P to the third conveyance path Ph3. The post-processing apparatus 3 further includes multiple sensors that detects the positions of the sheet P in the first conveyance path Ph1, the second conveyance path Ph2, and the third conveyance path Ph3. Each of the multiple sensors is indicated by a black triangle in FIG. 2.

The post-processing apparatus 3 includes the ejection tray 21. The sheet P that is ejected through the first conveyance path Ph1 rests on the ejection tray 21. Among the sheets P supplied from the image forming apparatus 2, the sheets P that are not bound are output to the ejection tray 21.

The post-processing apparatus 3 further includes the internal tray 22 serving as a placement tray, an end fence 23, side fences 24L and 24R, an edge binder 25, a staple binder 55 serving as a stapler, and the ejection tray 26. The internal tray 22, the end fence 23, the side fences 24L and 24R, the edge binder 25, and the staple binder 55 perform the edge binding on the sheet bundle Pb of multiple sheets P conveyed to the internal tray 22 from the second conveyance path Ph2.

Among the sheets P supplied from the image forming apparatus 2, the sheet bundle Pb subjected to the edge binding is ejected to the ejection tray 26.

In the following description, a direction in which the sheet P is conveyed from the conveyance roller pair 15 toward the end fence 23 is defined as a “conveyance direction” of the sheet P. In other words, the “conveyance direction” herein corresponds to a direction in which the sheet P that has been output from the image forming apparatus 2 is moved toward the ejection tray 26 by, for example, the conveyance roller pair 10 and then is moved toward the end fence 23 by the conveyance roller pair 15. A direction that is orthogonal to the conveyance direction and a thickness direction of the sheet P is defined as a “main scanning direction” or a “width direction of the sheet P.”

The sheets P that are sequentially conveyed through the second conveyance path Ph2 are temporarily placed on the internal tray 22 serving as a receptacle. The end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 55 bind an end of the sheet bundle Pb aligned by the end fence 23 and the side fences 24L and 24R. Then, the conveyance roller pair 15 ejects the sheet bundle Pb subjected to the edge binding to the ejection tray 26.

A detailed description is given of the edge binder 25 according to an embodiment of the present disclosure.

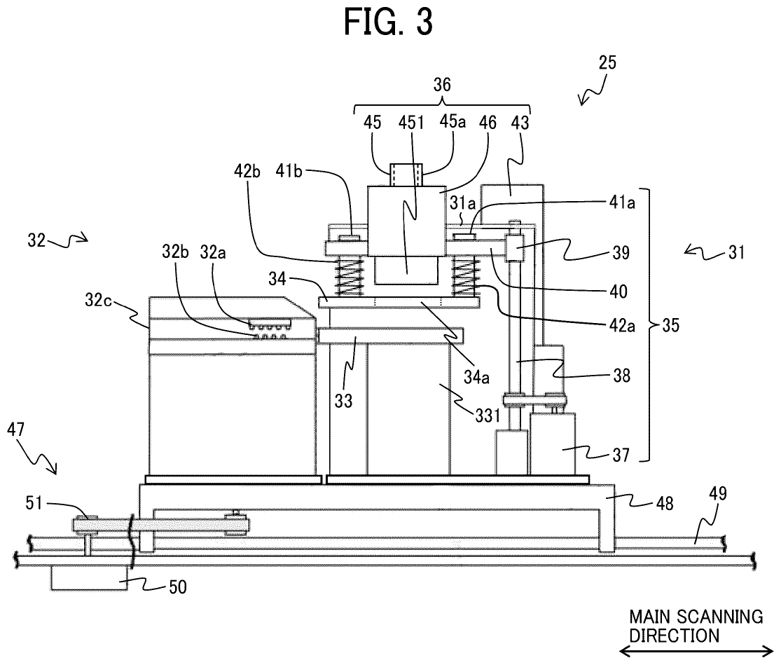

FIG. 3 is a schematic view of an upstream side of the edge binder 25 in the conveyance direction.

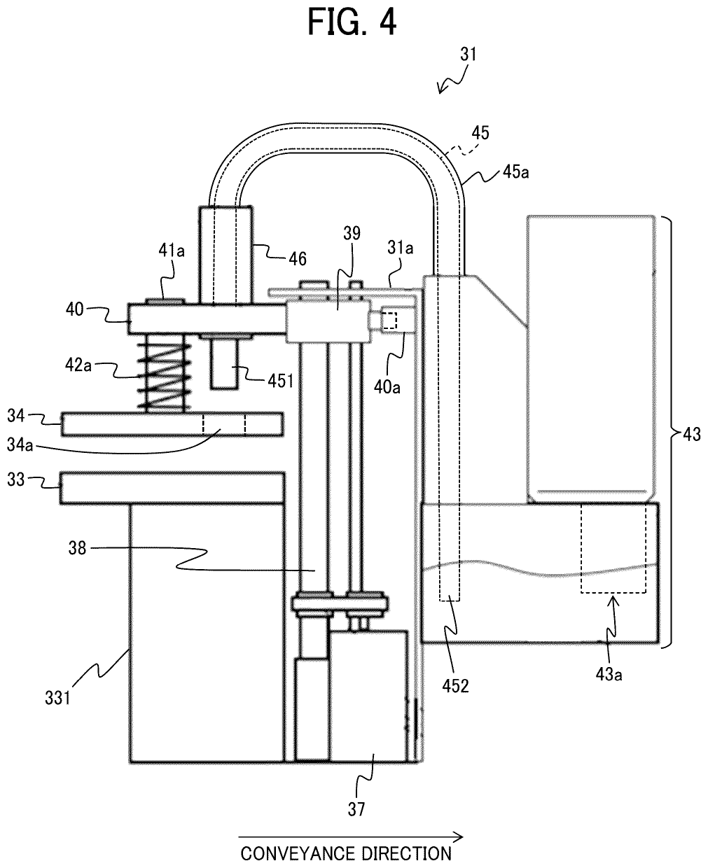

FIG. 4 is a schematic diagram illustrating a liquid applier 31 of the edge binder 25 when viewed from the main scanning direction.

As illustrated in FIG. 3, the edge binder 25 includes the liquid applier 31, and a crimper 32 that is an example of a post-processing device and serves as a crimp binder. The liquid applier 31 and the crimper 32 are disposed downstream from the internal tray 22 in the conveyance direction and adjacent to each other in the main scanning direction.

The liquid applier 31 applies liquid (for example, water) stored in a first liquid storage tank 43 as a first liquid storage unit to the sheet P or the sheet bundle Pb placed on the internal tray 22. In the following description, the application of liquid to the sheet P or the sheet bundle Pb may be referred to as “liquid application” whereas a process to apply liquid may be referred to as a “liquid application process.”

More specifically, the liquid that is stored in the first liquid storage tank 43 for the “liquid application” includes, as a main component, a liquid hydrogen-oxygen compound represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid storage tank 43 may include an additive in addition to the main component. The liquid that is stored in the first liquid storage tank 43 may include residual chlorine used as tap water. Preferably, for example, the liquid that is stored in the first liquid storage tank 43 may include, as an additive, a colorant, a penetrant, a pH adjuster, a preservative such as phenoxyethanol, a drying inhibitor such as glycerin, or a combination thereof. Since water is used as a component of ink used for inkjet printers or ink used for water-based pens, such water or ink may be used for the “liquid application.”

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above can enhance the binding strength of the sheet bundle Pb, in comparison with a liquid of which the main component is not water (liquid).

As illustrated in FIGS. 3 and 4, the liquid applier 31 is movable in the main scanning direction together with the crimper 32 by a driving force transmitted from a first binder movement motor 50. The liquid applier 31 includes a lower pressure plate 33 serving as a placement table for the sheet P or the sheet bundle Pb, an upper pressure plate 34, a liquid applier movement assembly 35, and a liquid application assembly 36. The components of the liquid applier 31 such as the lower pressure plate 33, the upper pressure plate 34, the liquid applier movement assembly 35, and the liquid application assembly 36 are held by a liquid application frame 31a and a base 48.

The lower pressure plate 33 and the upper pressure plate 34 are disposed downstream from the internal tray 22 in the conveyance direction. The lower pressure plate 33 supports, from below, the sheet P or the sheet bundle Pb placed on the internal tray 22. The lower pressure plate 33 is disposed on a lower pressure plate holder 331. The upper pressure plate 34 can move (up and down) in the thickness direction of the sheet P above the sheet P or the sheet bundle Pb placed on the internal tray 22. In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” Further, the upper pressure plate 34 has a through hole 34a penetrating in the thickness direction at a position facing the liquid application member 451 (one end portion of a liquid supply member 45 (liquid absorber) to be described later, which corresponds to a tip portion) attached to a base plate 40.

The liquid applier movement assembly 35 moves the upper pressure plate 34, the base plate 40, and the liquid application member 451 in the thickness direction of the sheet P or the sheet bundle Pb. The liquid applier movement assembly 35 according to the present embodiment moves the upper pressure plate 34, the base plate 40, and the liquid application member 451 in conjunction with each other with a single liquid applier movement motor 37. The liquid applier movement assembly 35 includes, for example, a liquid applier movement motor 37, a trapezoidal screw 38, a nut 39, the base plate 40, columns 41a and 41b, and coil springs 42a and 42b.

The liquid applier movement motor 37 generates driving force to move the upper pressure plate 34, the base plate 40, and the liquid application member 451. The trapezoidal screw 38 extends in a vertical direction in FIGS. 3 and 4 and is rotatably attached to the liquid application frame 31a. The trapezoidal screw 38 is coupled to an output shaft of the liquid applier movement motor 37 via, for example, a pulley and a belt. The nut 39 is screwed to the trapezoidal screw 38. The trapezoidal screw 38 is rotated by the driving force transmitted from the liquid applier movement motor 37. The rotation of the trapezoidal screw 38 moves the nut 39.

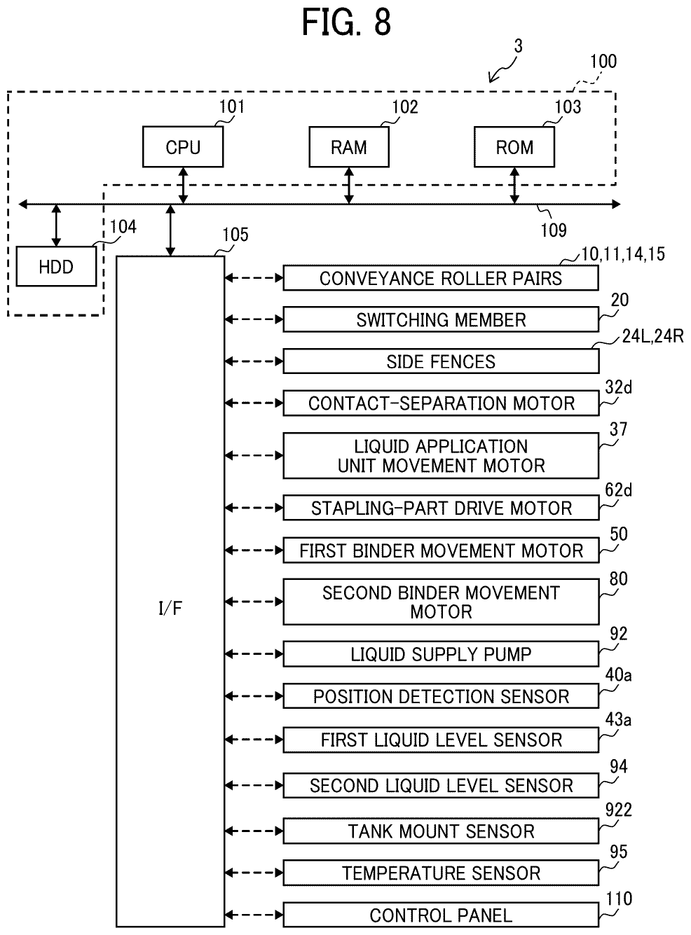

The base plate 40 is disposed above the upper pressure plate 34. The base plate 40 holds the liquid application member 451 with the end of the liquid application member 451 projecting downward. The base plate 40 is coupled to the trapezoidal screw 38 to move together with the trapezoidal screw 38. The position of the base plate 40 in the vertical direction is detected by a movement sensor 40a (see FIG. 8).

The columns 41a and 41b project downward from the base plate 40 around the end of the liquid application member 451. The columns 41a and 41b can relatively move with respect to the base plate 40 in the thickness direction. The columns 41a and 41b have respective lower ends holding the upper pressure plate 34. The columns 41a and 41b have respective upper ends provided with stoppers that prevent the columns 41a and 41b from being removed from the base plate 40. The coil springs 42a and 42b are fitted around the columns 41a and 41b, respectively, between the base plate 40 and the upper pressure plate 34. The coil springs 42a and 42b bias the upper pressure plate 34 and the columns 41a and 41b downward with respect to the base plate 40.

The liquid application assembly 36 applies liquid to the sheet P or the sheet bundle Pb placed on the internal tray 22. Specifically, the liquid application assembly 36 brings the liquid application member 451 into contact with the sheet P or the sheet bundle Pb to apply the liquid to at least one sheet P of the sheet bundle Pb. The liquid application assembly 36 includes the first liquid storage tank 43, the liquid supply member 45 including the liquid application member 451, and the joint 46.

The first liquid storage tank 43 stores the liquid to be supplied to the sheet P or the sheet bundle Pb. The surface of the liquid stored in the first liquid storage tank 43 is detected by a first liquid level sensor 43a serving as a first liquid detector.

The liquid supply member 45 serving as a liquid absorber has one end portion as the liquid application member 451 and the other end portion as a liquid immersion portion 452. The liquid immersion portion 452 is immersed in the liquid stored in the first liquid storage tank 43 and draws up the liquid to supply the liquid to the liquid application member 451. The liquid application member 451 is made of a material (e.g., sponge or fiber) having a high liquid absorption rate, such as an elastic resin formed of open cells.

The liquid supply member 45 is made of a material having a high liquid absorption rate, for example, similarly to the liquid application member 451. As a result, the liquid absorbed from the liquid immersion portion 452 of the liquid supply member 45 is supplied to the liquid application member 451 by the capillary action. In other words, the liquid immersion portion 452 has a configuration of drawing up the liquid stored in the first liquid storage tank 43 and supplying the liquid to the liquid application member 451, which is connected to the tip end of the liquid immersion portion 452 through the liquid supply member 45.

The liquid drawn up from the liquid immersion portion 452 is supplied to the liquid application member 451 through the liquid supply member 45, and the liquid application member 451 comes into contact with the uppermost surface of the sheets P or the sheet bundle Pb to apply the liquid. For this reason, the liquid application member 451 is supported by the base plate 40 with the tip end of the liquid application member 451 facing downward.

The liquid supply member 45 may be a unified body made of a material having a high liquid absorption rate. In other words, the liquid application member 451 may be part of the liquid supply member 45. In such a case, liquid can be supplied from the liquid supply member 45 to the liquid application member 451 more smoothly by the capillary action.

A protector 45a is an elongated cylindrical body (e.g., a tube) that is fitted around the liquid supply member 45. Accordingly, the protector 45a prevents the liquid absorbed by the liquid supply member 45 from leaking or evaporating. Each of the liquid supply member 45 and the protector 45a is made of a flexible material. The joint 46 fixes the liquid application member 451 to the base plate 40. Accordingly, the liquid application member 451 keeps projecting downward from the base plate 40 with the end of the liquid application member 451 facing downward, even when the liquid application member 451 is moved by the liquid applier movement assembly 35.

The crimper 32 presses and deforms the sheet bundle Pb with serrate binding teeth 32a and 32b to bind the sheet bundle Pb. In other words, the crimper 32 can bind the sheet bundle Pb without staples. The components of the crimper 32 such as the binding teeth 32a serving as upper crimping teeth and the binding teeth 32b serving as lower crimping teeth are disposed on a crimping frame 32c. In the following description, such pressure deformation on a given position on the sheet bundle Pb to bind the sheet bundle Pb may be referred to as “crimping.” In other words, the crimper 32 crimps the sheet bundle Pb or performs crimping on the sheet bundle Pb.

### Configuration of Binding Teeth 32a and 32b

A description is given below of the configuration of binding teeth 32a and 32b.

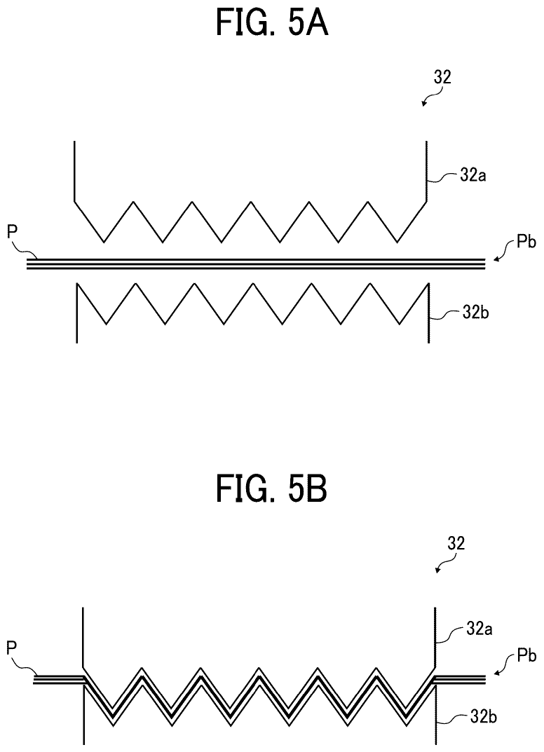

FIGS. 5A and 5B are schematic diagrams illustrating the configuration of the crimper 32.

As illustrated in FIGS. 5A and 5B, the crimper 32 includes the pair of binding teeth 32a and 32b. The binding teeth 32a and the binding teeth 32b are disposed to face each other in the thickness direction of the sheet bundle Pb so that the binding teeth 32a and the binding teeth 32b can sandwich the sheet bundle Pb placed on the internal tray 22. The binding teeth 32a and the binding teeth 32b have respective serrate faces facing each other. The serrate face of each of the binding teeth 32a and the binding teeth 32b includes concave portions and convex portions alternately formed. The concave portions and the convex portions of the binding teeth 32a are shifted from those of the binding teeth 32b such that the binding teeth 32a are engaged with the binding teeth 32b. The binding teeth 32a and the binding teeth 32b are brought into contact with and separated from each other by a driving force of a contact-separation motor 32d illustrated in FIG. 8.

In a process in which the sheets P of the sheet bundle Pb are supplied to the internal tray 22, the binding teeth 32a and the binding teeth 32b are apart from each other as illustrated in FIG. 5A. When all the sheets P of the sheet bundle Pb are placed on the internal tray 22, the pair of binding teeth 32a and binding teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped and bound. The sheet bundle Pb thus crimped and bound is output to the ejection tray 26 by the conveyance roller pair 15.

The configuration of the crimper 32 as a crimping assembly is not limited to the configuration of the present embodiment provided that the binding teeth 32a and the binding teeth 32b of the crimping assembly are engaged with each other. For example, the crimping assembly may bring the binding teeth 32a and the binding teeth 32b into contact with each other and separate the binding teeth 32a and the binding teeth 32b from each other with a link mechanism and a drive source that simply rotates forward or that rotates forward and backward (for example, the crimping assembly disclosed in Japanese Patent No. 6057167), or may bring the binding teeth 32a and the binding teeth 32b into contact with each other and separate the binding teeth 32a and the binding teeth 32b from each other linearly with a screw mechanism that converts rotational motion of the drive source in the forward and reverse directions into linear reciprocating motion.

As illustrated in FIG. 3, the edge binder 25 includes a first movement assembly 47. The first movement assembly 47 moves the edge binder 25 (i.e., the liquid applier 31 and the crimper 32) in the main scanning direction along the downstream end of the sheet P, which is placed on the internal tray 22, in the conveyance direction. The first movement assembly 47 includes, for example, the base 48, a guide shaft 49, the first binder movement motor 50, and a driving force transmission assembly 51.

The liquid applier 31 and the crimper 32 are attached to the base 48 such that the liquid applier 31 and the crimper 32 are adjacent to each other in the main scanning direction. The guide shaft 49 extends in the main scanning direction at a position downstream from the internal tray 22 in the conveyance direction. The guide shaft 49 supports the base 48 such that the base 48 can move in the main scanning direction. The first binder movement motor 50 generates a driving force for moving the edge binder 25.

The driving force transmission assembly 51 transmits the driving force of the first binder movement motor 50 to the base 48 via a pulley and a timing belt. As a result, the liquid applier 31 and the crimper 32 integrated by the base 48 move in the main scanning direction along the guide shaft 49. The position of the edge binder 25 may be ascertained with, for example, an encoder sensor attached to an output shaft of the first binder movement motor 50.

### Description of Staple Binder 55

A description is given of the staple binder 55.

A detailed description is now given of the staple binder 55 having the function of executing the stapling process.

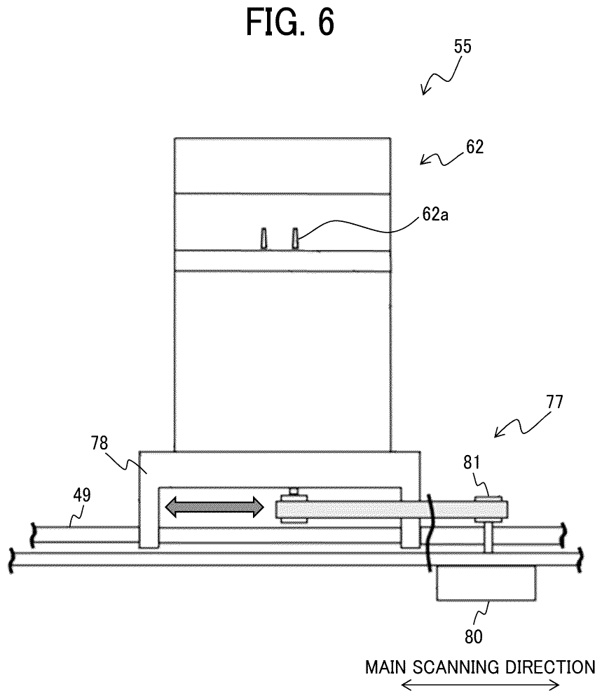

FIG. 6 is a schematic diagram illustrating the staple binder 55 as viewed from the upstream side in the conveyance direction.

The staple binder 55 includes a stapler 62 that binds a sheet bundle Pb with staples. The stapler 62 is disposed downstream from the internal tray 22 in the conveyance direction and spaced apart from the edge binder 25 in the main scanning direction.

The stapler 62 has a configuration for performing so-called “stapling” (i.e., stapling process) to bind the sheet bundle Pb with a staple or staples. To be more specific, the stapler 62 includes a stapling-part drive motor 62d illustrated in FIG. 8. The stapling-part drive motor 62d drives a stapling part 62a. The driving force of the stapling-part drive motor 62d causes a staple loaded in the stapling part 62a to penetrate through a sheet bundle Pb, so that the stapling part 62a binds the sheet bundle Pb. Since the stapler 62 has a typical configuration, a detailed description thereof will be omitted unless otherwise required.

As illustrated in FIG. 6, the staple binder 55 includes a second movement assembly 77. The second movement assembly 77 moves the staple binder 55 in the main scanning direction along a downstream end of the sheet P or the sheet bundle Pb placed on the internal tray 22 in the conveyance direction of the sheet P or the sheet bundle Pb. The second movement assembly 77 includes, for example, a base 78, a guide shaft 49, a second binder movement motor 80, and a driving force transmission assembly 81. Since the configuration of the second movement assembly 77 is common to that of the first movement assembly 47, the description thereof is omitted.

The edge binder 25 and the staple binder 55 are supported by the common guide shaft 49. In other words, the first movement assembly 47 and the second movement assembly 77 move the edge binder 25 and the staple binder 55 in the main scanning direction along the common guide shaft 49. The first movement assembly 47 and the second movement assembly 77 can move the edge binder 25 and the staple binder 55 independently of each other.

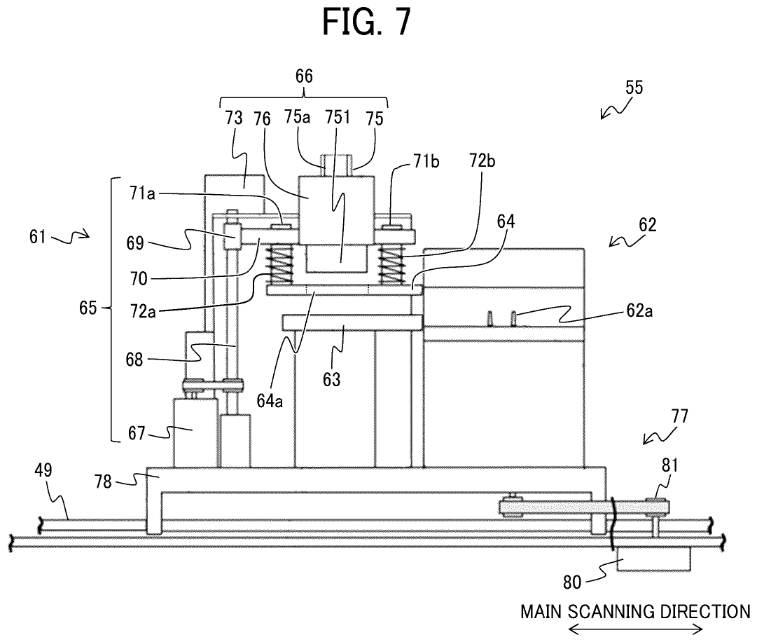

FIG. 7 illustrates a staple binder 55′ as a modification of the staple binder 55. More specifically, FIG. 7 is a schematic view of the staple binder 55′ as viewed from the upstream side in the conveyance direction.

The staple binder 55′ is different from the stapling unit 155 in that the stapling unit 155′ includes a second liquid applier 61 in addition to the stapler 62. As illustrated in FIG. 7, the staple binder 55′ includes the second liquid applier 61 and the stapler 62. The second liquid applier 61 and the stapler 62 are disposed downstream from the internal tray 22 in the conveyance direction and adjacent to each other in the main scanning direction.

The second liquid applier 61 executes “liquid application” of applying liquid (e.g., water) stored in a third liquid storage tank 73 to the sheet P or the sheet bundle Pb supported on the internal tray 22. A given area including a position to which the liquid is applied on the sheet P or the sheet bundle Pb by the second liquid applier 61 corresponds to a binding position to be stapled. As illustrated in FIG. 7, the second liquid applier 61 includes a second lower pressure plate 63, a second upper pressure plate 64, a second liquid applier movement assembly 65, and a second liquid application assembly 66. The second liquid applier movement assembly 65 includes, for example, a second liquid applier movement motor 67, a second trapezoidal screw 68, a second nut 69, a second base plate 70, second columns 71a and 71b, and second coil springs 72a and 72b. The second liquid application assembly 66 includes the third liquid storage tank 73, a second liquid supply member 75, a second liquid application member 751, and a second joint 76. Since the second liquid application assembly 66 and the liquid application assembly 36 have common configurations, redundant descriptions thereof are omitted below unless otherwise required.

In the stapling process, the staple binder 55 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without applying the liquid.

Referring back to FIG. 2, the post-processing apparatus 3 further includes an end fence 27, a saddle binder 28, a sheet folding blade 29, and the ejection tray 30. The end fence 27, the saddle binder 28, and the sheet folding blade 29 perform saddle binding on a sheet bundle Pb foamed of the sheets P that are conveyed through the third conveyance path Ph3. Among the sheets P supplied from the image forming apparatus 2, the sheet bundle Pb subjected to the saddle binding is ejected to the ejection tray 30.

The end fence 27 aligns the positions of the sheets P that are sequentially conveyed through the third conveyance path Ph3, in a direction in which the sheets P are conveyed. The end fence 27 can move between a binding position where the end fence 27 causes the center of the sheet bundle Pb to face the saddle binder 28 and a folding position where the end fence 27 causes the center of the sheet bundle Pb to face the sheet folding blade 29. The saddle binder 28 binds the center of the sheet bundle Pb aligned by the end fence 27 at the binding position. The sheet folding blade 29 folds, in half, the sheet bundle Pb placed on the end fence 27 at the folding position and causes the conveyance roller pair 18 to nip the sheet bundle Pb. The conveyance roller pairs 18 and 19 eject the sheet bundle Pb subjected to the saddle binding to the ejection tray 30.

### Control Block of Post-Processing Apparatus 3

A description is given of a control block of the post-processing apparatus 3.

A description is given below of a control block of the post-processing apparatus 3, with reference to FIG. 8.

FIG. 8 illustrates a hardware configuration for executing control processing executed in the post-processing apparatus 3.

As illustrated in FIG. 8, the post-processing apparatus 3 includes a central processing unit (CPU) 101, a random access memory (RAM) 102, a read only memory (ROM) 103, a hard disk drive (HDD) 104, and an interface (I/F) 105.

The CPU 101, the RAM 102, the ROM 103, the HDD 104, and the I/F 105 are connected to each other via a common bus 109.

The CPU 101 is an arithmetic unit and controls the overall operation of the post-processing apparatus 3.

The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, and the HDD 104 construct a controller 100 (control unit) that controls the operation of the post-processing apparatus 3.

The I/F 105 is an interface that connects the conveyance roller pairs 10, 11, 14, and 15, the switching member 20, the side fences 24L and 24R, the contact-separation motor 32d, the liquid applier movement motor 37, the stapling-part drive motor 62d, the first binder movement motor 50, the second binder movement motor 80, a liquid supply pump 92, the movement sensor 40a, the first liquid level sensor 43a, a second liquid level sensor 94, a tank mount detection sensor 922, a temperature sensor 95, and a control panel 110 to the common bus 109. The controller 100 operates, via the I/F 105, the conveyance roller pairs 10, 11, 14, and 15, the switching member 20, the side fences 24L and 24R, the contact-separation motor 32d, the liquid applier movement motor 37, the stapling-part drive motor 62d, the first binder movement motor 50, the second binder movement motor 80, and the liquid supply pump 92. The controller 100 acquires detection results from the movement sensor 40a, the first liquid level sensor 43a, the second liquid level sensor 94, the tank mount detection sensor 922, and the temperature sensors 95. Although FIG. 8 illustrates only the parts and components related to the edge binder 25 and the staple binder 55 that perform the edge binding, the parts and components related to the saddle binder 28 that performs the saddle binding are also controlled by the controller 100.

As illustrated in FIG. 1, the image forming apparatus 2 includes the control panel 110. The control panel 110 includes an operation device that receives instructions from a user and a display serving as a notifier that notifies the user of information. The operation device includes, for example, hard keys and a touch screen overlaid on the display. The control panel 110 acquires information from the user through the operation unit and provides the information to the user through the display. The specific example of the notifier is not limited to the display and may be, for example, a light emitting diode (LED) lamp or a speaker. The post-processing apparatus 3 may include the control panel 110 like the control panel 110 described above.

### Embodiments of Liquid Applier

A detailed description is given below of the medium processing apparatus according to a first embodiment of the present disclosure.

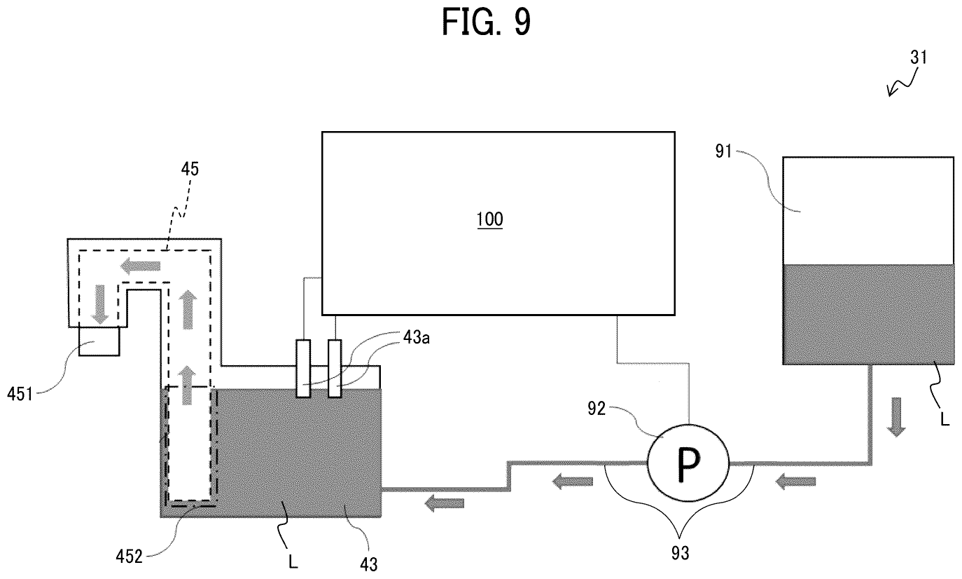

FIG. 9 is a diagram illustrating a configuration of the liquid applier 31 as a liquid applier according to a first embodiment of the present disclosure.

The liquid applier 31 includes a liquid supply member 45 having a liquid application member 451 and a liquid immersion portion 452, a first liquid storage tank 43 as a first liquid storage, a second liquid storage tank 91 as a second liquid storage, a liquid supply pump 92 and a liquid supply path 93 as a liquid supplier, and the controller 100 as a control unit.

As described above, the liquid supply member 45 is formed of a liquid absorber that has a portion (the liquid immersion portion 452) to be immersed in the liquid stored in the first liquid storage tank 43 and another portion (the liquid application member 451) to come into contact with a sheet P or a sheet bundle Pb to apply the liquid to the sheet P or the sheet bundle Pb.

The second liquid storage tank 91 stores liquid to be supplied to the first liquid storage tank 43. The liquid stored in the second liquid storage tank 91 is supplied to the first liquid storage tank 43 through the liquid supply path 93 by the operation of the liquid supply pump 92.

The first liquid storage tank 43 includes the first liquid level sensor 43a as a first liquid detector to detect the surface of the liquid (liquid surface). The first liquid level sensor 43a is an electrode sensor having a pair of electrodes.

A detection signal of the first liquid level sensor 43a is input to the controller 100 as a control unit. The controller 100 determines the amount of liquid in the first liquid storage tank 43 based on whether the input detection signal exceeds a liquid detection threshold value (threshold value). If the controller 100 determines that the liquid is to be replenished, the controller 100 operates the liquid supply pump 92 to supply the liquid from the second liquid storage tank 91 to the first liquid storage tank 43.

The controller 100 controls the timing of application of the voltage to the electrodes of the first liquid level sensor 43a. The controller 100 also controls the start and stop of the operation of the liquid supply pump 92 in accordance with the detection signal of the first liquid level sensor 43a. When the first liquid level sensor 43a detects the liquid (liquid level) in the first liquid storage tank 43 by the operation of the liquid supply pump 92 according to the detection signal of the first liquid level sensor 43a, the controller 100 stops the operation of the liquid supply pump 92 and also stops the voltage application to the first liquid level sensor 43a.

The controller 100 measures the elapsed time after the operation of the liquid supply pump 92 is stopped. When the elapsed time exceeds a first predetermined time, the controller 100B energizes (i.e., applies a voltage to) the electrodes of the first liquid level sensor 43a and performs the detection process of detecting the liquid (liquid level) in the first liquid storage tank 43 again.

It takes time for the liquid stored in the first liquid storage tank 43 to be drawn up by the capillary phenomenon of the liquid supply member 45 and sent from the liquid immersion portion 452 to the liquid application member 451 through the liquid supply member 45. For this reason, the controller 100 detects the surface of the liquid (liquid level) in the first liquid storage tank 43 after waiting for the given time to elapse as described above. At this time, if the liquid supply member 45 draws up the liquid, the surface of the liquid stored in the first liquid storage tank 43 decreases, and the first liquid level sensor 43a does not detect the liquid (liquid level) in the first liquid storage tank 43, the controller 100 causes the liquid supply pump 92 again to supply the liquid from the second liquid storage tank 91 to the first liquid storage tank 43.

The detection signal of the first liquid level sensor 43a corresponds to an electrical signal that changes according to the amount of contact of the electrodes with the surface of the liquid in the first liquid storage tank 43. Examples of the electrical signal include, but not limited to, a signal indicating an electrical resistance value, a signal indicating a voltage value, and a signal indicating a current value. In other words, the “electrical signal” may be any signal indicating an electrical value that changes when a current passes between the electrodes (when a voltage is applied) depending on whether the pair of electrodes of the electrode sensor is immersed in the liquid.

The electrode sensor is described as an example of the first liquid level sensor 43 a in the present embodiment. However, embodiments of the present disclosure are not limited to the electrode sensor, and any other method may be used. For example, a float sensor or a capacitance sensor may be used to detect the presence or absence of the liquid. The first liquid level sensor 43a is not limited to a sensor that detects the liquid level of the liquid in the first liquid storage tank 43, as long as the sensor can detect the presence or absence of the liquid in the first liquid storage tank 43.

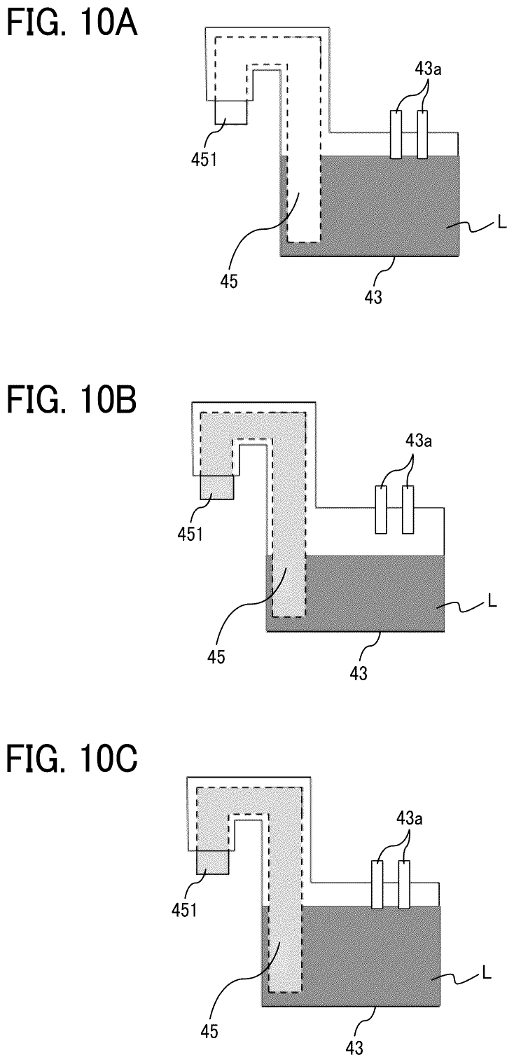

FIGS. 10A, 10B, and 10C are diagrams illustrating a change in the amount (liquid level) of the liquid stored in the first liquid storage tank 43 when the liquid supply member 45 is dry.

A change in the position of the surface of the liquid (liquid surface) is referred to as a “liquid level change” below.

As illustrated in FIG. 10A, liquid is supplied to the first liquid storage tank 43, so that the first liquid level sensor 43a detects the liquid surface in the first liquid storage tank 43. At this time, the liquid supply member 45 including the liquid immersion portion 452 is dry. The position of the liquid surface (the liquid level) when the first liquid level sensor 43a detects the liquid surface is referred to as a “reference liquid level”.

Then, as illustrated in FIG. 10B, the liquid is sucked up from the liquid immersion portion 452 by the capillary action, and the liquid supply member 45 is moistened with the sucked liquid. At this time, the amount (liquid level) of liquid stored in the first liquid storage tank 43 is lowered from the reference liquid level. At the stage when the liquid level is lowered, in other words, at the stage when the liquid supply member 45 is moistened by sucking the liquid, the controller 100 determines the electrical signal from the first liquid level sensor 43a again. When the controller 100 determines that the amount of liquid (liquid level) in the first liquid storage tank 43 is not at or above the reference liquid level, the controller 100 causes the liquid supply pump 92 to start the operation to supply liquid again.

In the case where an electrode sensor is used as the first liquid level sensor 43a, there is a concern that the metal used for the electrodes might be corroded due to electrolytic corrosion if the pair of electrodes is energized (applied with electricity) constantly. Further, since the voltage is always applied to the liquid stored in the first liquid storage tank 43, there is a concern that the liquid might be electrolyzed or that the electrodes might be dissolved due to adhesion of foreign matter to the surface of the electrodes by electrolysis, which might induce deterioration of the electrodes. For this reason, the controller 100 controls the timing of the energization of the first liquid level sensor 43a such that the first liquid level sensor 43a is not energized all the time but is energized only when the determination process of the change in the amount of liquid (liquid level) stored in the first liquid storage tank 43 is executed.

### Flow of Liquid Supply Determination Process

A description is given below of the liquid supply determination process.

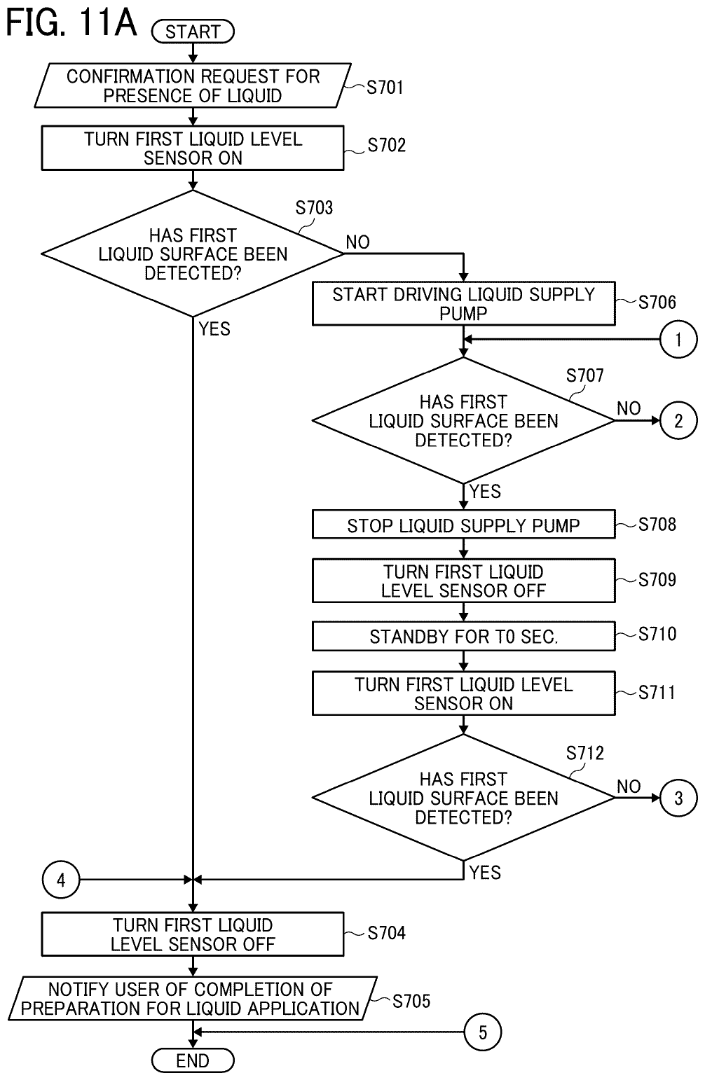

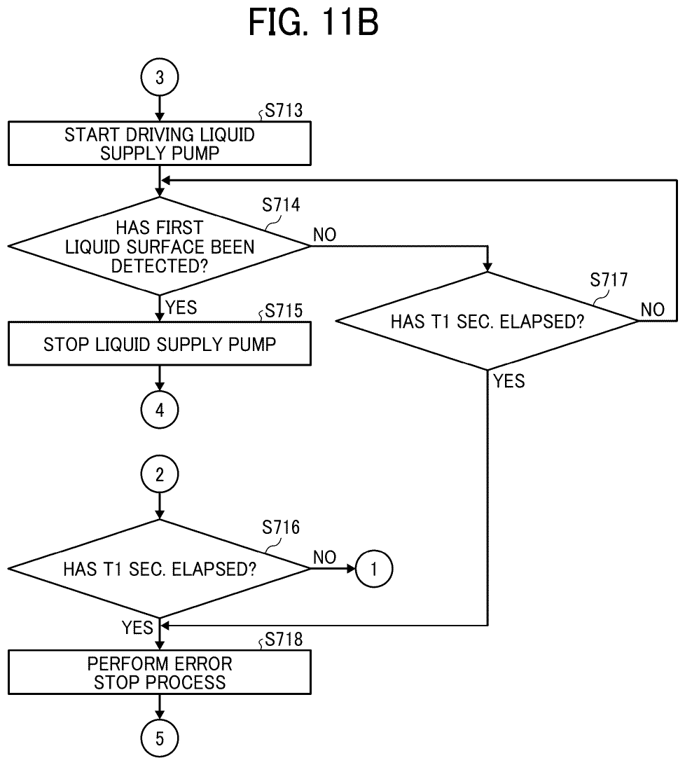

FIG. 11A is a flowchart including the first half of a liquid supply determination process executed by the controller 100, according to the first embodiment of the present disclosure.

FIG. 11B is a flowchart including the second half of the liquid supply determination process executed by the controller 100, according to the first embodiment of the present disclosure.

The liquid supply determination process according to the present embodiment is executed at the time of starting the post-processing apparatus 3 or at the time of starting the crimping process.

For example, when the post-processing apparatus 3 is activated, the liquid supply determination process is started, and a liquid presence check request is instructed to the controller 100 in step S701. The instruction of the liquid presence check request may be based on information input by the user from the control panel 110. Following the liquid presence check request, in step S702, the controller 100 applies a voltage to the first liquid level sensor 43a (i.e., turns the first liquid level sensor 43a on).

In step S703, the controller 100 acquires a value of an electrical signal (referred to as an “output value”) output when the first liquid level sensor 43a detects the surface of the liquid in the first liquid storage tank 43, and determines the presence or absence of the liquid (the amount of the liquid stored) in the first liquid storage tank 43. The presence or absence of liquid is determined based on whether the output value (voltage) output from the first liquid level sensor 43a exceeds a “liquid detection threshold value” (threshold value) set in advance. For example, when the output value (voltage) from the first liquid level sensor 43a is equal to or greater than the liquid detection threshold value (e.g., the output voltage VTh1), the controller 100 determines that there is a sufficient amount of liquid in the first liquid storage tank 43 (YES in step S703). In this case, the controller 100 stops the application of the voltage to the first liquid level sensor 43a (turns the first liquid level sensor 43a off) in step S704, and displays a completion notice of the preparation for liquid application on, for example, the control panel 110 in step S705, and ends the liquid supply determination process.

Alternatively, when the output value from the first liquid level sensor 43a is less than the liquid detection threshold value (e.g., the output voltage VTh1) (NO in step S703), in step S706, the controller 100 causes the liquid supply pump 92 to supply the liquid from the second liquid storage tank 91 to the first liquid storage tank 43.

Subsequently, when the output value (voltage) from the first liquid level sensor 43a is equal to or greater than the liquid detection threshold value (e.g., the output voltage VTh1), the controller 100 determines that there is a sufficient amount of liquid in the first liquid storage tank 43 (YES in step S707). Alternatively, when the output value (voltage) from the first liquid level sensor 43a is less than the liquid detection threshold value (e.g., the output voltage VTh1) (NO in step S707) and the elapsed time after the operation start of the liquid supply pump 92 (i.e., after step S706) does not exceed the abnormality determination time (T1 seconds) (NO in step S716), the liquid supply pump 92 continues to supply the liquid from the second liquid storage tank 91 to the first liquid storage tank 43 until the output value (voltage) from the first liquid level sensor 43a becomes equal to or greater than the liquid detection threshold value (e.g., the output voltage VTh1) (YES in step S707).

If the output value from the first liquid level sensor 43a does not become equal to or greater than the liquid surface (e.g., the output voltage VTh1) by the time when the abnormality determination time (T1 seconds) has elapsed (NO in step S707 and YES in step S716), the controller 100 determines that some abnormality has occurred in a device (for example, a failure in the first liquid level sensor 43a), and performs an error stop process (abnormality notification) of stopping the liquid supply pump 92 and turning the first liquid level sensor 43a off in step S718, and ends the liquid supply determination process.

In step S707, when the output value (voltage) from the first liquid level sensor 43a becomes equal to or greater than the liquid detection threshold value (e.g., the output voltage VTh1) (YES in step S707), in step S708, the controller 100 stops the liquid supply pump 92 to stop the supply of the liquid from the second liquid storage tank 91 to the first liquid storage tank 43. In step S709, the controller 100 stops the application of the voltage to the first liquid level sensor 43a (i.e., turns the first liquid level sensor 43a off).

Then, in step S710, the controller 100 temporarily stops the liquid supply determination process until a standby time (first predetermined time T0), which is set in advance as a time until the liquid supply member 45 completes the sucking of the liquid, has elapsed.

After the standby time (T0) has elapsed, the controller 100 turns the first liquid level sensor 43a on again in step S711, to determine the presence or absence of the liquid in the first liquid storage tank 43. At this stage, the (liquid storage amount) of the liquid in the first liquid storage tank 43 is lowered by the suction of the liquid supply member 45. However, if the output value from the first liquid level sensor 43a is equal to or greater than the liquid detection threshold value (e.g., the output voltage VTh1) (YES in step S712), in step S704, the controller 100 stops the application of the voltage to the first liquid level sensor 43a (i.e., turns the first liquid level sensor 43a off). In step S705, the controller 100 displays a completion notice of the preparation for liquid application on, for example, the control panel 110, and ends the liquid supply determination process.

On the other hand, when the output value (voltage) from the first liquid level sensor 43a is less than the liquid detection threshold value (e.g., the output voltage VTh1) in S712 (NO in step S712), in step S713, the controller 100 operates the liquid supply pump 92 to supply the liquid from the second liquid storage tank 91 to the first liquid storage tank 43.

Subsequently, when the output value (voltage) from the first liquid level sensor 43a is equal to or greater than the liquid detection threshold value (e.g., the output voltage VTh1), the controller 100 determines that there is a sufficient amount of liquid in the first liquid storage tank 43 (YES in step S714). In this case, in step S715, the liquid supply pump 92 stops the operation of supplying liquid. Then, the controller 100 stops the application of the voltage to the first liquid level sensor 43a (turns the first liquid level sensor 43a off) in step S704, displays a completion notice of the preparation for liquid application on, for example, the control panel 110 in step S705, and ends the liquid supply determination process.

On the other hand, when the output value (voltage) from the first liquid level sensor 43a is less than the liquid detection threshold value (e.g., the output voltage VTh1) (NO in step S714) and the elapsed time after the operation start of the liquid supply pump 92 (i.e., after step S713) does not exceed the abnormality determination time (T1 seconds) (NO in step S717), the liquid supply pump 92 continues to supply the liquid from the second liquid storage tank 91 to the first liquid storage tank 43 until the output value (voltage) from the first liquid level sensor 43a becomes equal to or greater than the liquid detection threshold value (e.g., the output voltage VTh1) (YES in step S714).

If the output value from the first liquid level sensor 43a does not become equal to or greater than the liquid detection threshold value (e.g., the output voltage VTh1) by the time when the abnormality determination time (T1 seconds) has elapsed (NO in step S714 and YES in step S717), in step S718, the controller 100 determines that some abnormality has occurred in a device (for example, a failure in the first liquid level sensor 43a), and performs an error stop process of stopping the liquid supply pump 92 and turning the first liquid level sensor 43a off.

A description is given below of the relation between the liquid supply determination process described above, with reference to FIGS. 10A, 10B, and 10C.

First, when the presence or absence of the liquid in the first liquid storage tank 43 is confirmed in the stage preceding to the state illustrated in FIG. 10A, the controller 100 determines that the liquid surface of the liquid in the first liquid storage tank 43 is not detected and the result is “no liquid” (NO in step S703), the controller 100 drives the liquid supply pump 92 to supply the liquid from the refill to the first liquid storage tank 43 in step S706. Then, when the stage enters to the state illustrated in FIG. 10A, the controller 100 stops the liquid supply pump 92 (YES in step S707).

Subsequently, when the standby time (T0) set in advance as the time that the liquid supply member 45 draws up liquid as illustrated in FIG. 10B, the liquid surface (liquid level) is lowered, and the output value (voltage) from the first liquid level sensor 43a is less than the liquid detection threshold value (e.g., the output voltage VTh1) (No in step S712). Then, the controller 100 operates the liquid supply pump 92 to supply the liquid from the second liquid storage tank 91 to the first liquid storage tank 43, so that the stage enters the state illustrated in FIG. 10C (YES in step S714).

### First Embodiment

A description is given below of a medium processing apparatus according to a first embodiment of the present disclosure.

The present embodiment relates to a structure and operation for assisting supply of liquid to a member that performs liquid application in order to enhance the binding force in crimp binding.

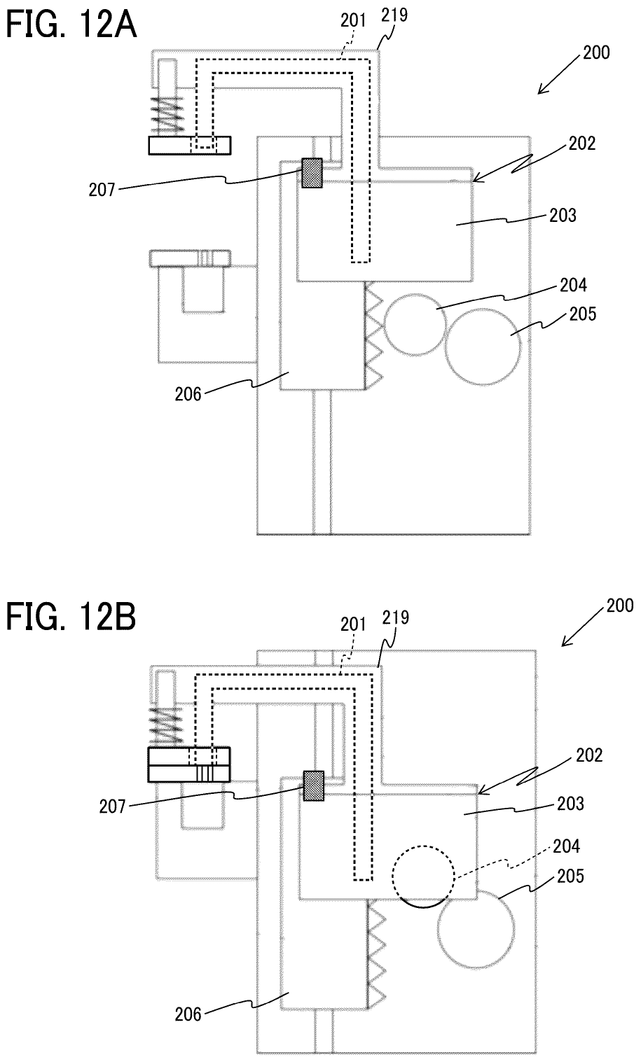

FIGS. 12A and 12B are diagrams illustrating a typical example of the liquid application device according to the present embodiment.

Although FIGS. 12A and 12B illustrate the configuration having the same functions as the functions of the liquid applier 31 described above, this example of a liquid application device includes the configuration according to the present embodiment. For the above reasons, similarly to the liquid applier 31 described above, a liquid application device 200 illustrated in FIGS. 12A and 12B also corresponds to the medium processing unit included in the post-processing apparatus 3.

The liquid application device 200 illustrated in FIGS. 12A and 12B includes a liquid storage tank 203 corresponding to the first liquid storage tank 43 included in the liquid applier 31. The liquid application device 200 includes a liquid supply member 201 that corresponds to the liquid application member 451 included in the liquid applier 31. In the following description, the liquid application device 200 includes a sensor similar to the first liquid level sensor 43a included in the liquid applier 31. The sensor is omitted in FIGS. 12A and 12B.

The liquid application device 200 causes the liquid supply member 201 to move liquid stored in the liquid storage tank 203 to execute liquid application to a sheet P. When the liquid in the liquid supply member 201 is consumed due to the liquid application, the liquid moves from the liquid storage tank 203 to the liquid supply member 201 in the liquid application device 200. The liquid application device 200 further include a liquid supply assisting mechanism for assisting the liquid supply operation so that the liquid moved from the liquid storage tank 203 to the liquid supply member 201 moves to the end portion of the liquid supply member 201 that contacts a sheet P in liquid application.

The liquid application device 200 illustrated in FIGS. 12A and 12B does not include a compression support movement mechanism for assisting the liquid supply operation. This configuration of the liquid application device 200 in FIGS. 12A and 12B corresponds to a configuration known in the art. The following description is given of the issues of a known configuration with reference to FIGS. 12A and 12B.

FIGS. 12A and 12B are diagrams illustrating the liquid application device 200 in which the amount (liquid amount) of liquid stored in the liquid storage tank 203 is sufficient, in other words, the liquid storage tank 203 is storing liquid more than the predetermined amount, and the position of the liquid level 202 is sufficiently high.

FIG. 12A illustrates the liquid application device 200 in which the sheet bundle Pb is receivable for liquid application.

FIG. 12B illustrates the liquid application device 200 ready for liquid application, in other words, the liquid application device 200 in which the liquid supply member 201 has moved toward the sheets P.

The sheet P is not depicted in FIG. 12.

In the liquid application device 200, the liquid supply member 201 sucks up the liquid stored in the liquid storage tank 203 by the capillary phenomenon of the liquid supply member 201. The liquid supply member 201 then moves the liquid supplied by the liquid storage tank 203 to the leading end portion (liquid application end portion) to which the liquid contacts. The liquid moved to the leading end portion of the liquid supply member 201 is applied to the sheet P when the leading end portion of the liquid supply member 201 moves toward the sheet P and comes into contact with the sheet P. This series of operations corresponds to liquid application.

The liquid supply member 201 of the liquid application device 200 is included in a liquid supply member case 219 that prevents the liquid stored in the liquid storage tank 203 from leaking from the vicinity of the liquid supply member 201 to which the sheet P contacts and a portion other than the vicinity of the trailing end portion of the liquid supply member 201 that contacts the liquid stored in the liquid storage tank 203. The liquid supply member case 219 is formed along the liquid supply member 201 from the liquid storage tank 203 and holds the liquid supply member 201.

The liquid stored in the liquid storage tank 203 is supplied to the liquid supply member 201 until the liquid amount sensor 207 is turned on at the time of activation of the post-processing apparatus 3 or before execution of the liquid application operation, as in the liquid supply determination process (see FIGS. 11A and 11B) described above as an example of the liquid applier 31. In the present embodiment, as in the liquid supply determination process illustrated in FIGS. 11A and 11B, the controller 100 determines whether a sufficient amount of liquid is stored in the liquid storage tank 203 as an initial process before the binding operation with liquid application is performed. When the amount of liquid (liquid amount) stored in the liquid storage tank 203 is insufficient, liquid is supplied to the liquid storage tank 203.

As will be described below, the liquid application device 200 measures the number of times of liquid application in the control program executed by the controller 100, and executes an assisting operation for assisting the liquid supply operation of moving liquid to the leading end portion of the liquid supply member 201 according to the number of times of liquid application. The number of times of liquid application in the present embodiment is the number of times of liquid application determined based on the number of formation of the sheet bundles Pb (the number of sheet bundles) designated in a job including post-processing and the number of sheets P used in a unit of the sheet bundle Pb. In other words, the number of times of liquid application in the present embodiment corresponds to the number of times of liquid application in a job to be executed. In the present embodiment, when the liquid supply member 201 performs the liquid application operation, the liquid application device 200 is controlled to perform an operation for assisting the liquid supply in accordance with the number of times of the liquid application operations.

The liquid supply member 201 is movable in the vertical direction integrally with the liquid storage tank 203 by, for example, a supply member rack 206, a supply member drive gear 204, and a supply member drive source 205. By the movement in the vertical direction, one end portion of the liquid supply member 201 comes into contact with the sheet P and performs liquid application. At the same time, the other end portion, that is, the end portion of the liquid supply member 201 on the side not in contact with the sheet P moves up and down by the execution of liquid application while maintaining a state in which the other end portion of the liquid supply member 201 is in contact with the liquid stored in the liquid storage tank 203.

Since both the liquid applier 31 described above and the liquid application device 200 use the capillary phenomenon, the supply speed at which the liquid stored in the liquid storage tank 203 is supplied to the leading end portion through the liquid supply member 201 depends on the height from the liquid level 202 (liquid surface) and the contact area with the liquid.

Accordingly, when the liquid in the liquid storage tank 203 is consumed due to liquid application and the liquid level 202 lowers less than the predetermined amount, the speed at which the liquid supply member 201 sucks up the liquid stored in the liquid storage tank 203 may decrease according to the degree of lowering of the liquid. In the present embodiment, the speed at which the liquid supply member 201 sucks up the liquid from the liquid storage tank 203 by the capillary phenomenon is referred to as “liquid supply speed”.

When the liquid supply speed is reduced, particularly when the liquid application in a large amount is performed, the amount of liquid applied to the sheet P from the liquid supply member 201 by liquid application is reduced, and the liquid application may be insufficient.

In order to address this inconvenience, in the present embodiment, the vertical movement of the liquid application device 200 is controlled so as to execute a liquid supply assisting operation for assisting a reduction in the liquid supply speed of the liquid supply member 201 in accordance with the number of times of liquid application. The liquid supply assisting operation is an operation to cause the liquid supply member 201 and the liquid storage tank 203 to vertically move not in the same direction by the same amount but in the same direction by the different amounts. By performing such an operation, the liquid supply member 201 can be compressed inside the liquid storage tank 203. Further, by causing the liquid supply member 201 and the liquid storage tank 203 to move by the different amounts from each other, even when the liquid supply member 201 and the liquid storage tank 203 are caused to move in the same direction (a direction of liquid application), the operation of supplying liquid to the liquid supply member 201 can be assisted. This operation restrains, or prevents, a decrease in the liquid supply speed to the liquid supply member 201. Due to such a configuration, the liquid application can be continuously performed while maintaining the appropriate amount of liquid to be applied to the sheet P by the liquid application.

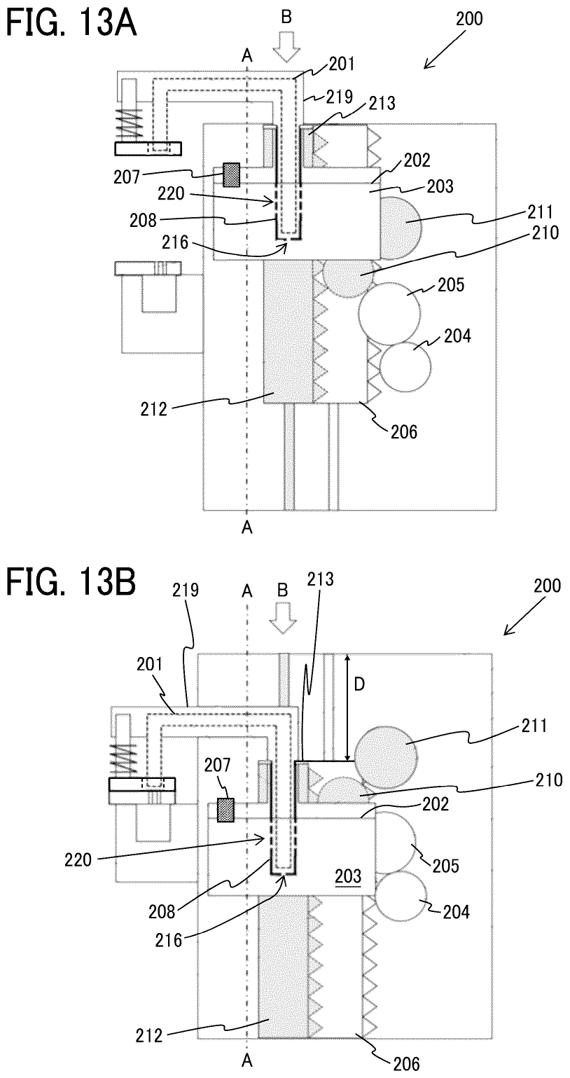

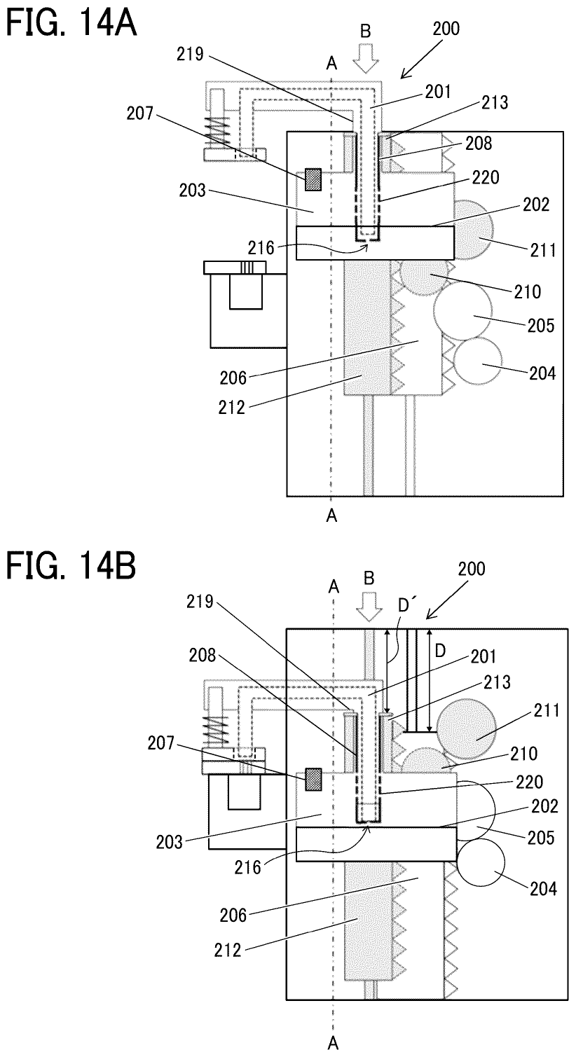

FIGS. 13A, 13B, 14A and 14B illustrate a configuration of the liquid application device 200 according to the present embodiment, including a liquid application member movement mechanism for performing a liquid supply assisting operation to the liquid supply member 201 in the liquid application device 200.

FIGS. 13A and 13B are diagrams illustrating the liquid application device 200 in which the amount (liquid amount) of liquid stored in the liquid storage tank 203 is sufficient, in other words, the liquid storage tank 203 is storing liquid equal to or more than the predetermined amount, and the position of the liquid level 202 is at sufficiently a high position.

FIG. 13A illustrates the liquid application device 200 that is ready to receive a sheet P for liquid application to a sheet P.

FIG. 13B illustrates the liquid application device 200 in which liquid application is being performed on the sheet P.

FIGS. 14A and 14B are diagrams illustrating the liquid application device 200 in which the amount (liquid amount) of liquid stored in the liquid storage tank 203 is reduced to an insufficient amount, in other words, an amount of liquid less than the predetermined amount, and the position of the liquid level 202 is at a low position.

FIG. 14A illustrates the liquid application device 200 that is ready to receive a sheet P for liquid application to a sheet P.

FIG. 14B illustrates the liquid application device 200 in which liquid application is being performed on the sheet P.

The liquid application device 200 according to the present embodiment further includes a compression support 208 having a cylindrical shape so as to cover a part of the liquid supply member 201, and a compression support movement mechanism for moving the compression support 208 in the vertical direction. When the liquid supply member 201 performs an approaching operation of approaching the sheet P in the liquid application operation, the compression support movement mechanism can compress or extend the liquid supply member 201 in response to the approaching operation of the liquid supply member 201. The expansion and contraction of the liquid supply member 201 assists the liquid supply.

The states illustrated in FIGS. 13A and 13B are examples in which the sufficient amount of liquid is stored in the liquid storage tank 203, the liquid level 202 is sufficiently high, and a sheet P or a sheet bundle Pb is receivable at the liquid application position. In these states, the compression support 208 and a drive device (compression drive device) of the compression support movement mechanism perform the same operation as the drive device (liquid application drive device) that moves the liquid supply member 201 and the liquid storage tank 203 up and down (in the vertical direction).

The compression drive device that moves the compression support 208 in the vertical direction includes a support drive source 211, a support drive gear 210, and a support rack 212. The compression support movement mechanism performs a predetermined moving operation by the compression drive device.

In other words, when the liquid level in the liquid storage tank 203 is sufficient and the liquid level 202 is at a high position, the supply member drive source 205, the supply member drive source 205, the supply member drive gear 204, and the supply member rack 206 that drive the liquid supply member 201 and the liquid storage tank 203 and the compression drive device that drives the compression support 208 perform the same operation. Accordingly, the liquid supply operation is performed by not compressing the liquid supply member 201 but moving the liquid supply member 201 in the vertical direction as illustrated in FIGS. 12A and 12B.

In the states illustrated in FIGS. 14A and 14B, in other words, when the amount of liquid in the liquid storage tank 203 and a sheet bundle Pb is to be received, the operation is different from the above-described operation. For example, as illustrated in FIG. 14B, the compression support 208 is driven by the compression drive device (i.e., the support drive source 211, the support drive gear 210, and the support rack 212) separately from the driving of the liquid supply member 201.

In the state illustrated in FIG. 14B, the liquid supply member 201 is in contact with the bottom face of the compression support 208. As a result, the liquid supply member 201 is relatively pushed upward and compressed. The compression of the liquid supply member 201 causes the liquid stored in the liquid supply member 201 to be pressed out. As a result, a part of the liquid pressed out from the liquid supply member 201 is reabsorbed by the liquid supply member 201, and the liquid gains the flow force in the upward direction due to the flow. Thus, the liquid application in the upward direction can be assisted.

The compression support 208 has side face support holes 220 in the side face. The liquid that has overflowed from the left and right sides of the liquid supply member 201 is accumulated in the gap between the compression support 208 and the liquid supply member 201, and leaks out from the side face support holes 220 to the liquid storage tank 203. Due to such a configuration, the liquid level 202 of the liquid stored in the liquid storage tank 203 is raised.

In the capillary phenomenon, the speed at which the liquid supply member 201 absorbs the liquid (referred to as “liquid absorption speed” or “liquid flow speed”) depends on the relative difference in height between the liquid supply member 201 and the liquid level 202 and the contact area in which the liquid supply member 201 contacts the liquid. (no translation) For this reason, the rise of the position of the liquid level 202 with respect to the bottom of the liquid supply member 201 assists the liquid supply operation with respect to the liquid supply member 201.

As illustrated in FIG. 14B, when the liquid application device 200 performs the liquid application and changes back to receive a sheet P as illustrated in FIG. 14A, the compression support 208 is moved down to a position lower than the liquid supply member 201. Due to this action, the liquid supply member 201 is decompressed or released from the compression. The liquid lost from the liquid supply member 201 due to the liquid application is supplied through support holes 216 in, for example, the bottom face of the compression support 208 or the side face support holes 220 in the side face of the compression support 208.

As illustrated in FIG. 14B, the amount of movement of the liquid application drive device in the vertical direction in the liquid application operation is referred to as a “first liquid application movement amount D1”. Further, the amount of movement of the compression drive device in the vertical direction for assisting the liquid supplying operation is referred to as a “second liquid application movement amount D2”.

As illustrated in FIG. 14B, when the amount of liquid stored in the liquid storage tank 203 is little, the liquid level 202 is low, and the liquid supply speed in the liquid supplying operation is low, the first liquid application movement amount D1 and the second liquid application movement amount D2 are set to different amounts, and the liquid supply member 201 is compressed to assist the liquid supply operation.

### Control Process Flow of First Embodiment

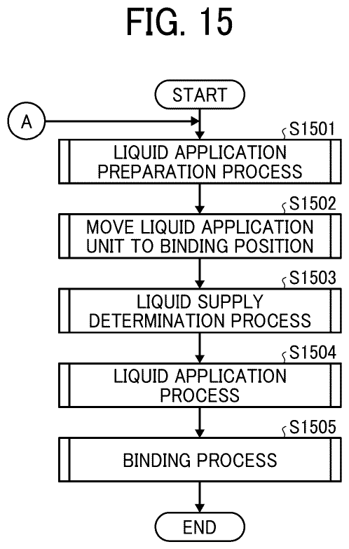

A description is given below of the flow of an operation control process in the liquid application device 200 according to a first embodiment of the present disclosure with reference to the flowcharts of FIGS. 15, 16, and 17.

FIG. 15 is a flowchart of a liquid supply process according to the first embodiment of the present disclosure.

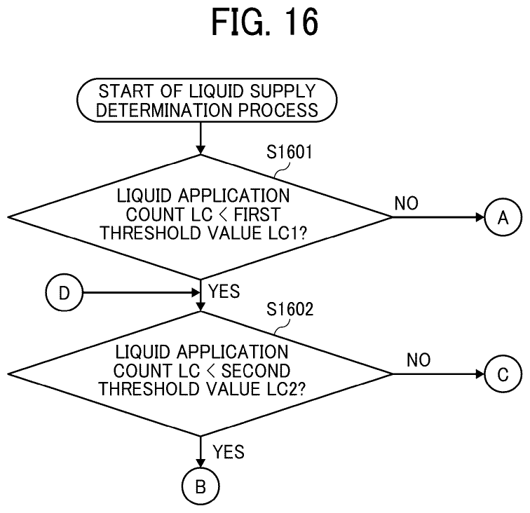

FIG. 16 is a flowchart of a liquid supply process in connection to the liquid supply process of the flowchart of FIG. 15, according to the first embodiment of the present disclosure.

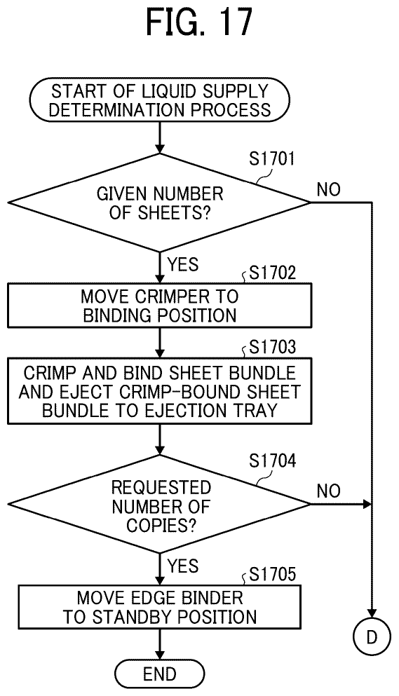

FIG. 17 is a flowchart of a liquid supply process in connection to the liquid supply process of the flowchart of FIG. 16, according to the first embodiment of the present disclosure.

The operation control process to be described below is an example of a control process that can be done by executing a given control program in the controller 100 as described above.

First, at the start of a binding operation accompanied by liquid application, in step S1501, the controller 100 performs a liquid application preparation process. The liquid application preparation process is a process similar to the liquid supply determination process described with reference to FIGS. 11A and 11B, and performs the replenishment of liquid to the liquid storage tank 203 and the supply of the liquid to the liquid supply member 201, so that the liquid application can be executed by the liquid supply member 201. The detailed description of the liquid application preparation process is omitted here.

Subsequently, the liquid application device 200 is moved to the binding position. In other words, in step S1502, after a sheet P is received, the controller 100 causes the liquid application device 200 to move to a position at which the liquid application can be performed to the binding position.

Subsequently, in step S1503, the liquid supply determination process is performed. FIG. 16 is a flowchart of the flow of the liquid supply determination process. In the liquid supply determination process, the number of times of the liquid application operations executed after completion of the liquid application preparation process is calculated based on the number of sheet bundles Pb formed in the binding process and the number of sheets P per sheet bundle Pb. The controller 100 determines whether the liquid application preparation process (step S1501), a non-compression liquid application process (to be described below), or a compression liquid application process (to be described below) is performed based on whether a “liquid application count LC” that is the number of times of liquid application operations exceeds at least two threshold values.

First, in step S1601, the controller 100 determines whether the liquid application count LC is less than a first threshold value LC1. When the liquid application count LC is less than the first threshold value LC1 (YES in step S1601), the controller 100 changes the process to the liquid supply determination process (to Process A in the flowchart of FIG. 15). When the liquid application count LC is equal to or greater than the first threshold value LC1 (NO in step S1601), it is likely that the liquid becomes short in the middle of the liquid application. For this reason, the controller 100 performs the liquid supply determination process (step S1501) again to eliminate this inconvenience. As a result, the amount of liquid in the liquid storage tank 203 is replenished while the first liquid level sensor 43a detects the liquid amount, and the liquid is also supplied to the liquid supply member 201.

If the liquid application count LC is less than the first threshold value LC1 (YES in step S1601), in step S1602, the controller 100 determines whether the liquid application count LC is less than a second threshold value LC2. When the liquid application count LC is less than the second threshold value LC2 (YES in step S1602), the controller 100 changes the process to the non-compression liquid application process to Process B. Details of the non-compression liquid application process will be described below.

When the liquid application count LC is not less than the second threshold value LC2, in other words, the liquid application count LC is equal to or greater than the second threshold value LC2 (NO in step S1602), the controller 100 changes the process to the non-compression liquid application process to Process C. Details of the compression liquid application process will be described below.

The first threshold value LC1 is greater than the second threshold value LC2 (the first threshold value LC1>the second threshold value LC2).

The description is given below with reference again to the flowchart in FIG. 15.

Following the liquid supply determination process (step S1503), the liquid application process is executed (step S1504). In the liquid application process, one of two different processes is executed depending on the result of the determination process (step S1602) in the liquid supply determination process (step S1503). The details of the liquid application process will be described below.

Subsequently, in step S1505, the controller 100 executes the binding process.

FIG. 17 is a flowchart illustrating the flow of the binding process.

In the liquid application process (step S1504), the same operation for the binding process is performed in any liquid application regardless of whether the liquid application is performed with or without compressing the liquid supply member 201. First, in step S1701, the controller 100 determines whether the number of sheets P to which the liquid application is performed reaches a “given number of sheets” for forming a requested number of sheet bundle Pb designated in the job.

When the number of sheets P to which the liquid application is performed has not reached the given number of sheets (NO in step S1701), the controller 100 changes the process to the liquid application determination process (step S1602) (to Process D). In contrast, when the number of sheets P to which the liquid application is performed reaches the given number of sheets (YES in step S1701), in step S1702, the controller 100 causes the binder to the binding position (step S1702). In step S1703, the controller 100 causes the sheet bundle Pb subjected to the binding process to be ejected to the ejection tray.

Then, in step S1704, the controller 100b determines whether the number of sheet bundles Pb thus ejected to the ejection tray reaches the requested number of sheet bundles Pb (the requested number of copies) designated in the job. When the number of sheet bundles Pb is not the requested number of copies (NO in step S1704), the controller 100 changes the process to the liquid application determination process (steps S1502, S1602). When the number of sheet bundles Pb reaches the requested number of copies (YES in step S1704), in step S1705, the controller 100 causes the edge binder to the standby position, and ends the process.

### Flow of Non-Compression Liquid Application Process According to First Embodiment

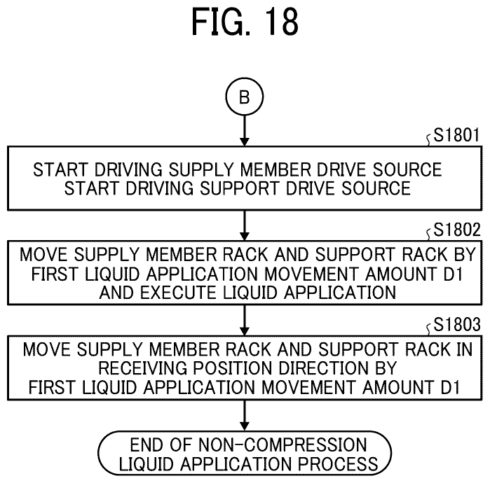

A description is below given of an example of the non-compression liquid application process that is executed when the liquid application count LC is not less than the second reference value LC2 as a result of the liquid supply determination process (S1602: YES), with reference to the flowchart of FIG. 18.

FIG. 18 is a flowchart of a liquid supply process in connection to the liquid supply process of the flowchart of FIG. 16, according to the first embodiment of the present disclosure.

First, in step S1801, the controller 100 starts driving the supply member drive source 205 and the support drive source 211. Subsequently, in step S1802, the controller 100 causes the supply member rack 206 and the support rack 212 to move in the direction for liquid application by the first liquid application movement amount D1 and execute the liquid application on the sheet P.

Subsequently, in step S1803, the controller 100 causes the supply member rack 206 and the support rack 212 to move in a direction toward a receiving position (receiving position direction) by the first liquid application movement amount D1, and ends the non-compression liquid application process. This process corresponds to the operation described with reference to FIGS. 13A and 13B.

### Flow of Compression Liquid Application Process According to First Embodiment

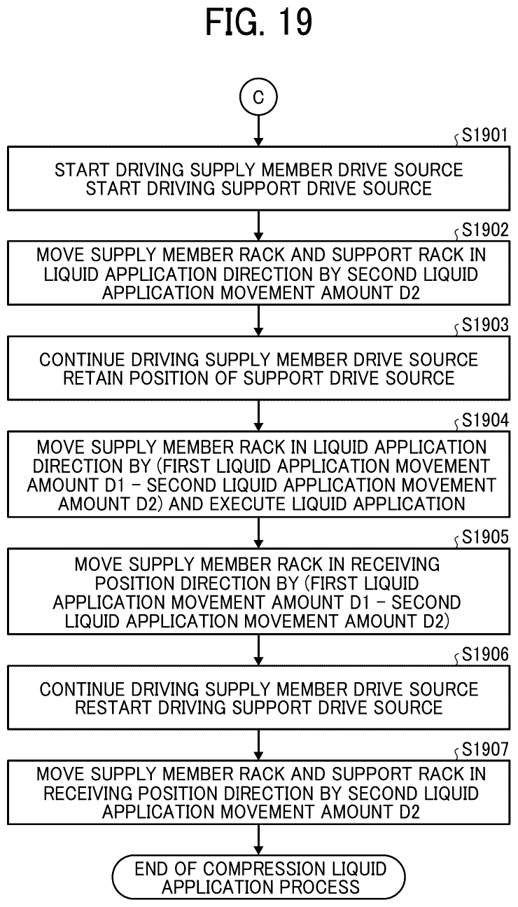

A description is below given of an example of the compressed liquid application process that is executed when the liquid application count LC is not less than the second reference value LC2, in other words, when the liquid application count LC is equal to or greater than the second threshold value LC2, as a result of the liquid supply determination process (S1602: NO), with reference to the flowchart of FIG. 19.

FIG. 19 is a flowchart of a liquid supply process in connection to the liquid supply process of the flowchart of FIG. 16, according to the first embodiment of the present disclosure.

First, in step S1901, the controller 100 starts driving the supply member drive source 205 and the support drive source 211. Subsequently, in step S1902, the controller 100 causes the supply member rack 206 and the support rack 212 to move in the direction toward the sheet P (liquid application direction) by the second liquid application movement amount D2 and execute the liquid application on the sheet P.

Subsequently, in step S1903, the controller 100 continues driving the supply member drive source 205 to retain the position of the support drive source 211.

Subsequently, in step S1904, the controller 100 causes the supply member rack 206 to further move in the direction toward the sheet P to perform liquid application on the sheet P. The amount of movement at this time is satisfied by the equation of “the first liquid application movement amount D1”−“the second liquid application movement amount D2”.

Subsequently, in step S1905, the controller 100 causes the supply member rack 206 to be received by the amount of “the first liquid application movement amount D1”−“the second liquid application movement amount D2” to move the supply member rack 206 in the receiving position direction.

Subsequently, in step S1906, the controller 100 continues driving the supply member drive source 205 and restarts the driving of the support drive source 211.

Subsequently, in step S1907, the controller 100 causes the supply member rack 206 and the support rack 212 to move in the receiving position by the second liquid application movement amount D2.

As described above, in the compression liquid application process, at the time when the supply member rack 206 and the support rack 212 move by the second liquid application movement amount D2, the support drive source 211 holds the position, and the supply member drive source 205 continues to move. Accordingly, the supply member rack 206 moves by the first liquid application movement amount D1, and the support rack 212 moves by the second liquid application movement amount D2. Thus, the liquid supply member 201 can perform the liquid application on the sheet P while being compressed by the compression support 208.

After the liquid application on the sheet P, the controller 100 causes the supply member drive source 205 to reversely rotate and move in the receiving position direction by the amount of “the first liquid application movement amount D1−the second liquid application movement amount D2”. From that point in time, similarly to the supply member drive source 205, the support drive source 211 starts reverse rotation and moves by the second liquid application movement amount D2. By so doing, the movement to the original receiving position is completed.

A further detailed description is given below of the members included in the liquid application device 200.

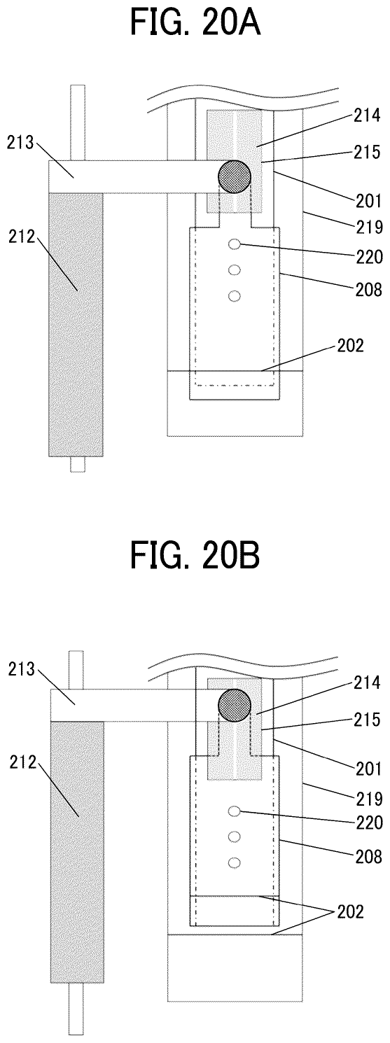

FIG. 20A is a partial enlarged view of the liquid application device 200 according to the first embodiment of the present disclosure, viewed from the left side face of the liquid application device 200 taken along a line A-A in FIG. 14A.

The liquid application device 200 of FIG. 20A illustrates that the position of the liquid level 202 is at or below a certain height.

FIG. 20B is a partial enlarged view of the liquid application device 200 according to the first embodiment of the present disclosure, viewed from the left side face of the liquid application device 200 taken along the line A-A in FIG. 14B.

The liquid application device 200 of FIG. 20B illustrates that the position of the liquid level 202 is at or below a certain height.

As illustrated in FIGS. 20A and 20B, the liquid supply member case 219 has an opening 215 at a juncture of the compression support 208 and the support rack 212. The compression support drive member 213 functions as a transmission member to transmit the driving force from the support rack 212 to the compression support 208 and is coupled to the compression support 208 via the opening 215. As illustrated in FIGS. 20A and 20B, the opening 215 is provided with a valve 214 as a valve member including an elastic material such as rubber. The compression support drive member 213 that drives the compression support 208 passes through a gap having a slit shape. By so doing, the opening 215 can prevent leakage of the liquid from the coupling portion.

The compression support 208 has the side face support holes 220 in the side face for liquid supply, so that the liquid supply from the liquid storage tank 203 can be performed efficiently.

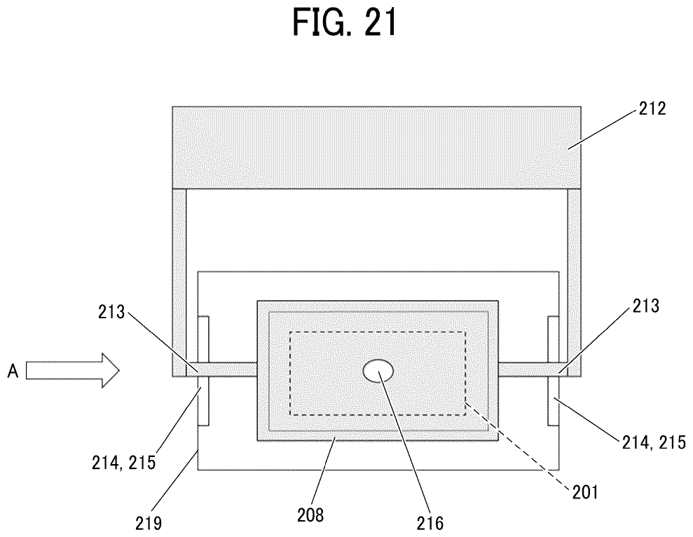

FIG. 21 is a partial enlarged view of the liquid application device 200 according to the first embodiment of the present disclosure.

FIG. 21 illustrates the relative positions of the liquid supply member 201 and the support rack 212, from the viewpoint B in FIGS. 13A, 13B, 14A and 14B and from directly above the liquid supply member 201 and the support rack 212.

In FIG. 21, the compression support 208 is disposed so as to surround the four sides and the depth direction of the liquid supply member 201. A support hole 216 having a diameter smaller than the diameter of the liquid supply member 201 is in the bottom face of the compression support 208 in the depth direction of the liquid supply member 201. Due to such a configuration, the liquid stored in the liquid storage tank 203 can be supplied to the inside of the compression support 208.

### Second Embodiment

A description is given below of a driving mechanism included in the liquid application device 200 according to a second embodiment of the present disclosure.

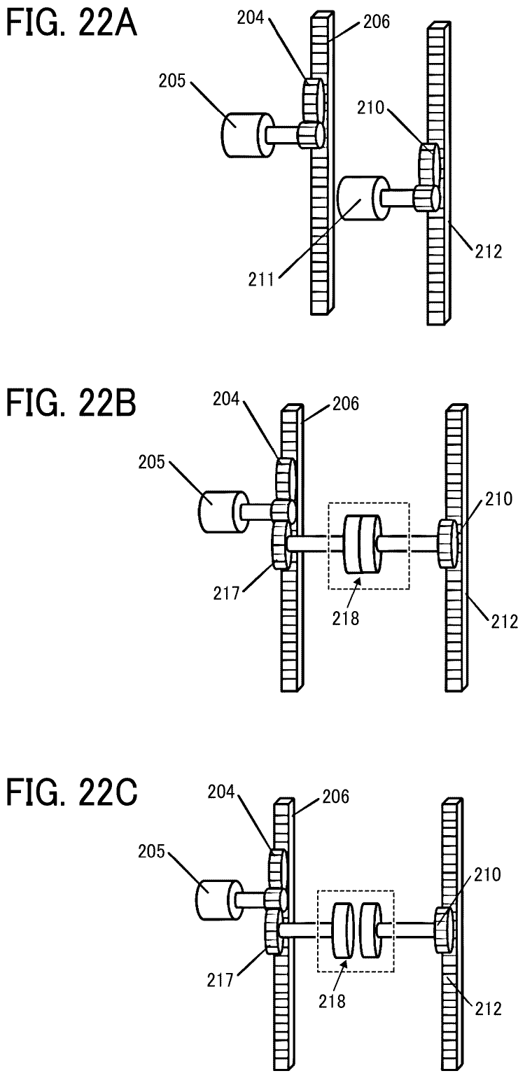

FIGS. 22A, 22B and 22C are diagrams illustrating the liquid application device 200 according to a second embodiment of the present disclosure.

Specifically, FIG. 22A is an example of a drive device when the supply member drive source 205 and the support drive source 211 drive the supply member rack 206 and the support rack 212, respectively and separately.

FIG. 22B illustrates the liquid application device 200 further including a clutch 218 as a coupler in the drive device, and the clutch 218 is ON.

FIG. 22C illustrates the liquid application device 200 further including the clutch 218 added to the drive device, and the clutch 218 is OFF.

The operation of the compression support 208 described with reference to FIGS. 13A, 13B, 14A and 14B can be performed by the configuration with the supply member drive source 205 and the support drive source 211 as illustrated in FIG. 12, for example, but can also be performed by the configuration with the clutch 218 being switched as illustrated in FIGS. 22B and 22C.

FIG. 22B illustrates the state where the clutch 218 is ON. When the clutch 218 is ON, the supply member drive source 205 drives the supply member rack 206 via the supply member drive gear 204, and drives the support rack 212 by simultaneously operating the support drive gear 210 via the gear 217 and the clutch 218. When the clutch 218 is ON, the liquid supply member 201 is not compressed by the compression support 208.

FIG. 22C illustrates the state where the clutch 218 is OFF. When the clutch 218 is OFF, the driving force is not transmitted to the support drive gear 210 and the support rack 212. Due to such a configuration, the relative positions of the liquid storage tank 203 and the liquid supply member 201 are maintained. Further, since the supply member rack 206 is disposed at the front stage of the clutch 218, when the liquid level in the liquid storage tank 203 is equal to or lower than a certain level, the clutch 218 is switched between ON and OFF. By so doing, the operation to compress the liquid supply member 201 by a single supply member drive source 205 can be executed.

### Flow of Non-Compression Liquid Application Process According to Second Embodiment

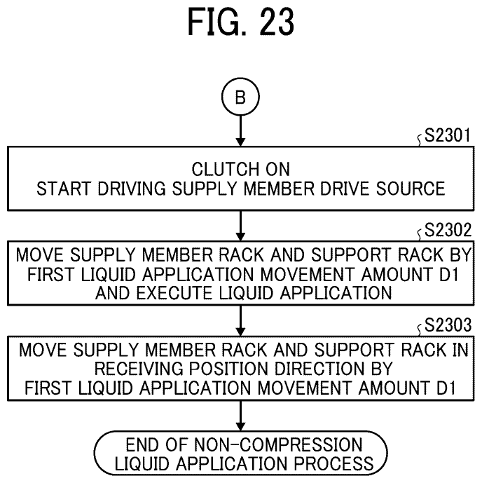

A description is below given of another example of the non-compression liquid application process that is executed when the liquid application count LC is less than the second reference value LC2 as a result of the liquid supply determination process (S1602: YES), with reference to the flowchart of FIG. 23. This example indicates a non-compression liquid application process in which the clutch 218 illustrated in FIGS. 22B and 22C is switched.

FIG. 23 is a flowchart of the liquid supply process according to the second embodiment of the present disclosure.

First, in step S2301, the controller 100 turns the clutch 218 ON and starts driving the supply member drive source 205. Subsequently, in step S2302, the controller 100 causes the supply member rack 206 and the support rack 212 to move in the direction for liquid application by the first liquid application movement amount D1 and execute the liquid application on the sheet P.

Subsequently, in step S2303, the controller 100 causes the supply member rack 206 and the support rack 212 to move in the receiving position direction by the first liquid application movement amount D1, and ends the non-compression liquid application process.

### Flow of Compression Liquid Application Process According to Second Embodiment

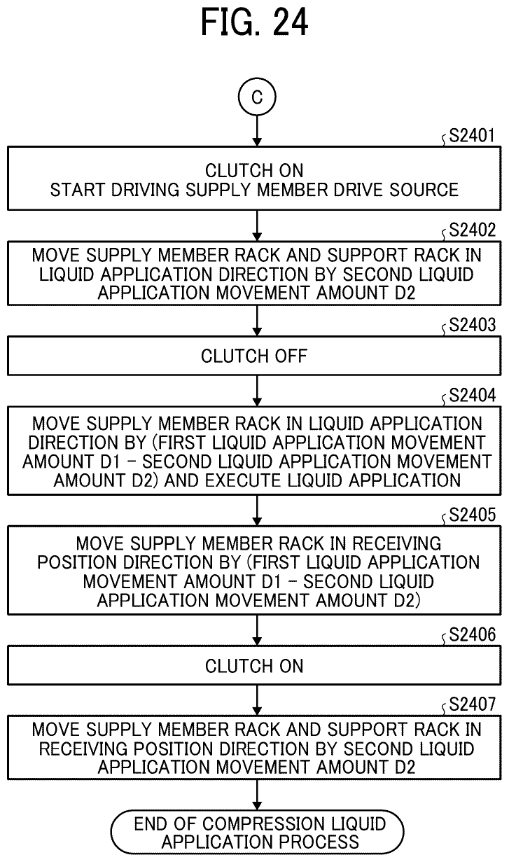

A description is below given of another example of the compression liquid application process that is executed when the liquid application count LC is not less than the second reference value LC2, in other words, when the liquid application count LC is equal to or greater than the second threshold value LC2, as a result of the liquid supply determination process (S1602: NO), with reference to the flowchart of FIG. 24. This example indicates a compression liquid application process in which the clutch 218 illustrated in FIGS. 22B and 22C is switched.

FIG. 24 is a flowchart of a liquid supply process according to the second embodiment of the present disclosure.

First, in step S2401, the controller 100 turns the clutch 218 ON and starts driving the supply member drive source 205. Subsequently, in step S2402, the controller 100 causes the supply member rack 206 and the support rack 212 to move in the direction toward the sheet P (liquid application direction) by the second liquid application movement amount D2.

Subsequently, in step S2403, the clutch 218 is turned OFF.

Subsequently, in step S2404, the controller 100 further moves the supply member rack 206 in the sheet direction (liquid application direction) to perform liquid application. The amount of movement at this time is satisfied by the equation of “the first liquid application movement amount D1”−“the second liquid application movement amount D2”.

Subsequently, in step S2405, the controller 100 causes the supply member rack 206 to be received by the amount of “the first liquid application movement amount D1”−“the second liquid application movement amount D2” to move the supply member rack 206 in the receiving position direction.

Subsequently, in step S2406, the controller 100 causes the clutch 218 to be turned on and continues driving the supply member drive source 205.

Subsequently, in step S2407, the controller 100 causes the supply member rack 206 and the support rack 212 to move in the receiving position by the second liquid application movement amount D2.

In the compression liquid application process according to the first embodiment, the stop and drive of the support drive source 211 is switched to move the liquid supply member 201 to the position at which the compression support 208 compresses the liquid. However, in step S2403, in the compression liquid application process according to the second embodiment, the clutch 218 is turned off to hold the position of the compression support 208 to be the position of the second liquid application movement amount D2, and the liquid supply member 201 moves as it is to apply the liquid. After step S2403, in step S2406, the controller 100 causes the supply member drive source 205 to be reversely rotated, and turns ON the clutch 218 again at the time when the supply member drive source 205 is moved by the amount of movement of “the first liquid application movement amount D1”−“the second liquid application movement amount D2” in the receiving position direction. After step S2406, the controller 100 causes the supply member rack 206 and the support rack 212 to move to the receiving position.

### Another Embodiment of Post-Processing Apparatus

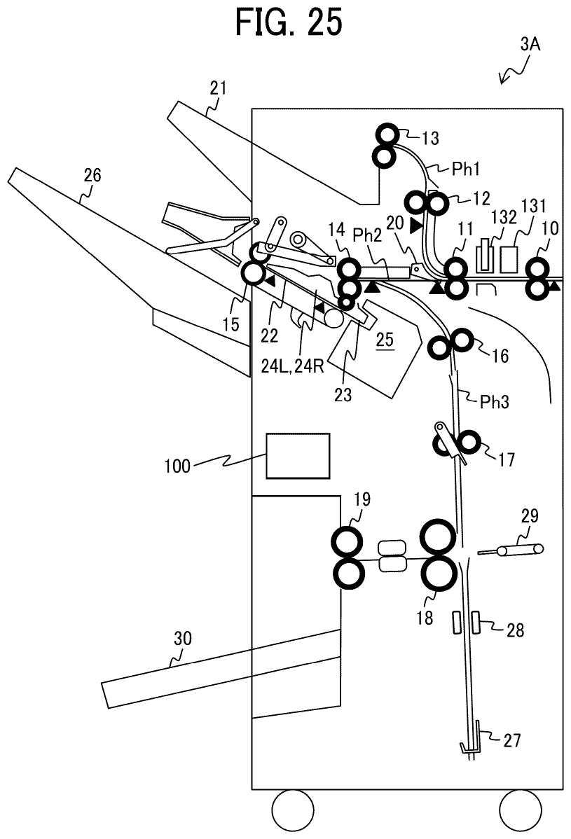

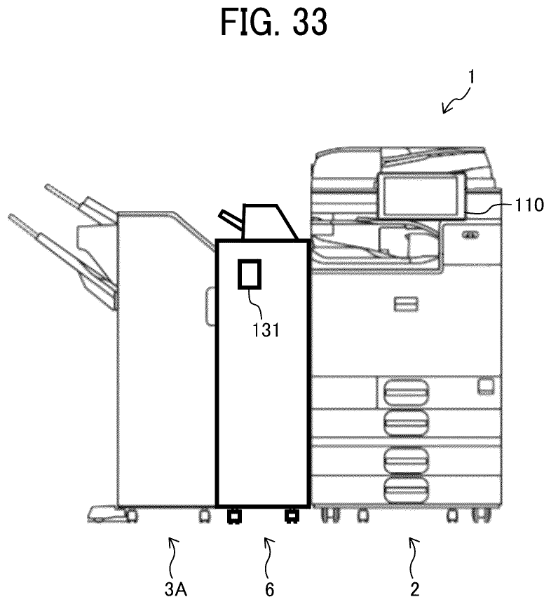

Referring now to FIGS. 25 to 33, a description is given of a post-processing apparatus 3A according to another embodiment of the present disclosure.

In the following description, components like those of the above-described embodiment are denoted by like reference numerals, and detailed descriptions thereof may be omitted.

The post-processing apparatus 3A according to the second embodiment is different from the post-processing apparatus 3 according to the first embodiment in which the liquid applier 131 and the crimper 32 are arranged side by side. In the post-processing apparatus 3A according to the second embodiment, a liquid applier 131 is disposed alone at an upstream position in a direction in which the sheet P is conveyed. Such a configuration allows a given number of sheets P to be stacked after the liquid is applied and conveyed to the crimper 32 of the edge binder 25 disposed at a downstream position in the direction in which the sheet P is conveyed. Accordingly, the productivity of the binding process performed by the crimper 32 is enhanced. Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P is defined as the “main scanning direction” or the “width direction of the sheet P.” The position (liquid application position) to which the liquid is applied on the sheet P or the sheet bundle Pb by the liquid applier 131 corresponds to the binding position on the sheet bundle Pb to be crimped by the crimper 32. For this reason, in the following description, the liquid application position and the binding position are denoted by the same reference sign.

FIG. 25 is a diagram illustrating an internal configuration of the post-processing apparatus 3A according to another embodiment of the present disclosure.

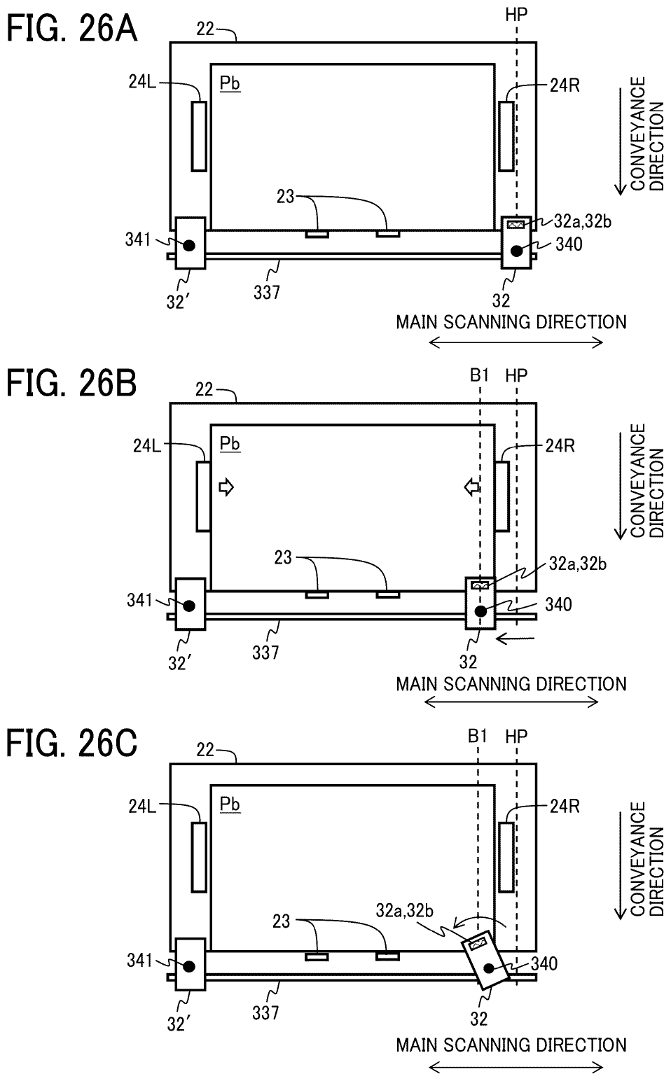

FIGS. 26A, 26B, and 26C are diagrams each illustrating an internal tray of the post-processing apparatus 3A of FIG. 25, viewed from the thickness direction of a sheet.

As illustrated in FIGS. 26A, 26B, and 26C, the edge binder 25 includes the crimper 32 and a stapler 32′.

As illustrated in FIGS. 26A, 26B, and 26C, the crimper 32 and the stapler 32′ are disposed downstream from the internal tray 22 in the conveyance direction. In addition, the crimper 32 and the stapler 32′ are located to face a downstream end, in the conveyance direction, of the sheet bundle Pb placed on the internal tray 22 and move in the main scanning direction. Further, the crimper 32 and the stapler 32′ are pivoted about an axis extending in the thickness direction of the sheet bundle Pb placed on the internal tray 22. In other words, the crimper 32 and the stapler 32′ bind, at a desired angle, a desired position in the main scanning direction on the sheet bundle Pb placed on the internal tray 22 in, for example, corner oblique binding, parallel one-point binding, or parallel two-point binding.

The crimper 32 presses and deforms the sheet bundle Pb with serrate binding teeth 32a and 32b to bind the sheet bundle Pb. In the following description, such a binding way may be referred to as “crimp binding.” In other words, the crimper 32 crimps and binds the sheet bundle Pb or performs the crimp binding on the sheet bundle Pb. On the other hand, the stapler 32′ passes the staple through a binding position on the sheet bundle Pb placed on the internal tray 22 to staple the sheet bundle Pb.

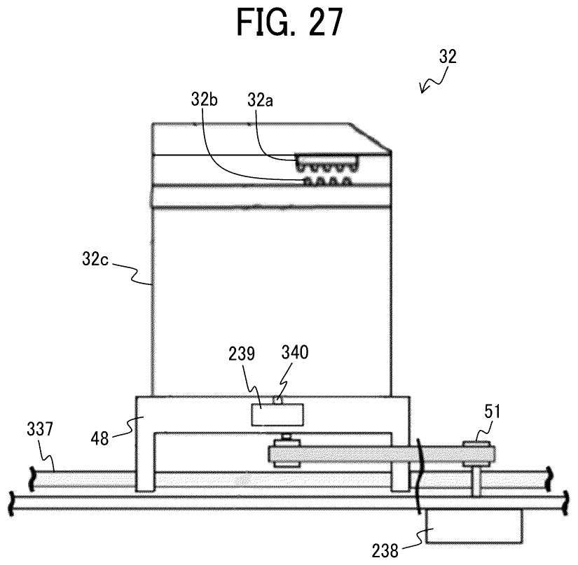

FIG. 27 is a schematic view of the crimper 32 as viewed from the downstream side in the conveyance direction.

As illustrated in FIGS. 26A, 26B, and 26C, the crimper 32 and the stapler 32′ are disposed downstream from the internal tray 22 in the conveyance direction.

The crimper 32 moves in the main scanning direction along the surface of the sheet bundle Pb placed on the internal tray 22. The crimper 32 is also pivoted about a pivot 340 extending in the thickness direction of the sheet bundle Pb placed on the internal tray 22. Similarly, the stapler 32′ moves in the main scanning direction of the sheet bundle Pb and is pivoted about a pivot 341 extending in the thickness direction of the sheet bundle Pb. The other components of the stapler 32′ are similar to, even if not the same as, the components of the staple binder 55 (see FIG. 6) of the post-processing apparatus 3 according to the first embodiment. For this reason, a detailed description the components of the stapler 32′ is omitted.

More specifically, as illustrated in FIG. 27, a guide rail 337 extending in the main scanning direction is disposed downstream from the internal tray 22 in the conveyance direction. The crimper 32 is moved in the main scanning direction along the surface of the sheet bundle Pb placed on the internal tray 22, in other words, along the guide rail 337, by a driving force transmitted from a crimper movement motor 238 by a drive transmission assembly 240 including a pulley and a timing belt. The pivot 340 is fixed to a bottom face of the crimping frame 32c that holds the components of the crimper 32. The pivot 340 is rotatably held by the base 48 on which the crimping frame 32c is disposed. When a driving force is transmitted from a pivot motor 239 to the pivot 340, the crimper 32 is pivoted about the pivot 340 extending in the thickness direction of the sheet P placed on the internal tray 22. The guide rail 337, the crimper movement motor 238, the pivot motor 239, the pivot 340, and the drive transmission assembly 240 construct a driving assembly of the crimper 32.

The crimper 32 is movable between the standby position HP illustrated in FIG. 26A and a position where the crimper 32 faces the binding position B1 illustrated in FIGS. 26B and 26C. The standby position HP is away in the main scanning direction from the sheet bundle Pb placed on the internal tray 22. For example, in FIGS. 22A, 22B, and 22C, the standby position HP is away from the right side of the sheet bundle Pb in the main scanning direction. The binding position B1 is a position on the sheet bundle Pb placed on the internal tray 22. However, the specific position of the binding position B1 is not limited to the position illustrated in FIGS. 26B and 26C. The binding position B1 may be one or more positions along the main scanning direction at the downstream end, in the conveyance direction, of the sheet P.

The posture of the crimper 32 changes or is pivoted between a parallel binding posture illustrated in FIG. 26B and an oblique binding posture illustrated in FIG. 26C. The parallel binding posture is a posture of the crimper 32 in which the longitudinal direction of the pair of binding teeth 32a and binding teeth 32b (in other words, the rectangular crimping binding trace) is oriented in the main scanning direction. The oblique binding posture is a posture of the crimper 32 in which the length of the pair of binding teeth 32a and binding teeth 32b (in other words, the rectangular crimp binding trace) is inclined with respect to the main scanning direction.

The pivot angle, which is an angle of the binding teeth 32a and the binding teeth 32b with respect to the main scanning direction), in the oblique binding posture is not limited to the angle illustrated in FIG. 26C. The pivot angle in the oblique binding posture may be any angle provided that the binding teeth 32a and the binding teeth 32b face the sheet bundle Pb placed on the internal tray 22.

The post-processing apparatus 3A includes the liquid applier 131 and a hole punch 132. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19. The liquid applier 131 and the hole punch 132 according to the present embodiment are disposed between the conveyance roller pairs 10 and 11. However, the arrangement of the liquid applier 131 and the hole punch 132 is not limited to the embodiment illustrated in FIG. 19. For example, in a case where an inserter 6 is disposed between the image forming apparatus 2 and the post-processing apparatus 3A as illustrated in FIG. 27, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

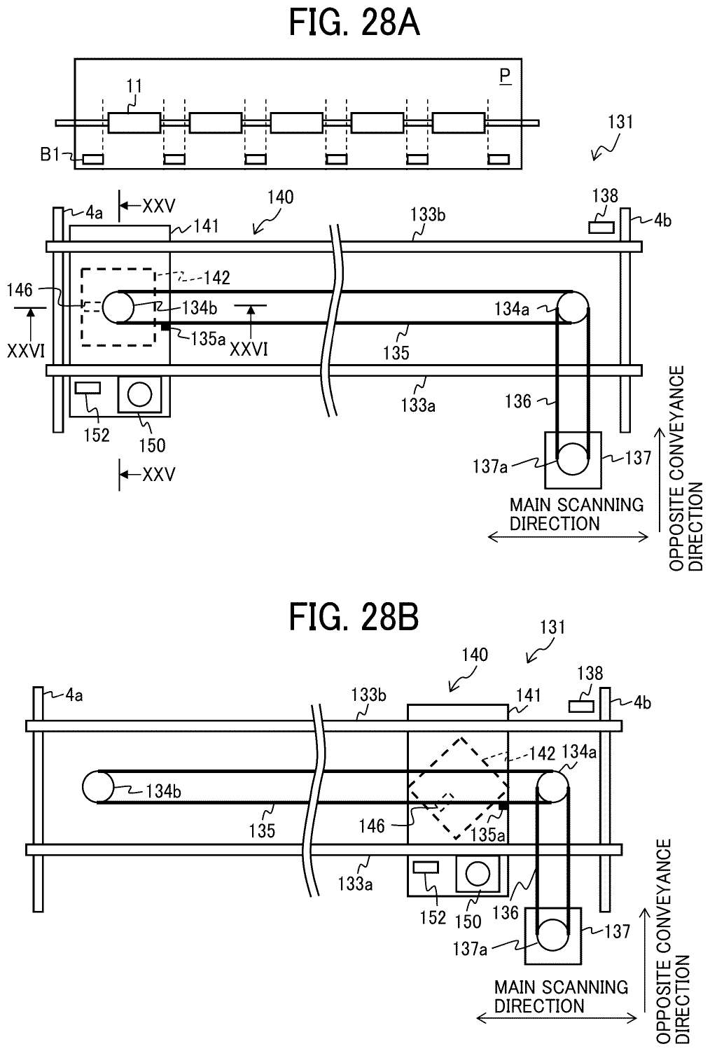

FIGS. 28A and 28 are schematic views of a liquid application device of the post-processing apparatus 3A of FIG. 25, viewed from the thickness direction of a sheet.

As illustrated in FIG. 28A, the conveyance roller pair 11 is located so as not to overlap, in the main scanning direction, the liquid application position B1 on the sheet P to which the liquid has been applied by a liquid application head 146 of the liquid applier 131. This arrangement is to prevent the amount of liquid at the liquid application position B1 from decreasing due to the multiple roller pairs pressing the liquid application position B1 when the conveyance roller pair 11 conveys the sheet P. As a result, when the sheet P reaches the crimper 32 disposed downstream from the liquid applier 131 in the opposite conveyance direction, the amount of liquid at the liquid application position B1 is sufficient to maintain the binding strength. Accordingly, the binding strength of the sheet bundle Pb is prevented from decreasing due to a decrease in the amount of liquid at the liquid application position B1 while the sheet P is conveyed.

In addition, the multiple roller pairs of the conveyance roller pair 11 that is located so as not to overlap the liquid application position B1 on the sheet P in the main scanning direction prevents the conveying performance of the sheet P from being worse due to the adhesion of liquid to the multiple roller pairs and further prevents a conveyance jam caused by the worsened conveying performance of the sheet P.

Although only the conveyance roller pair 11 has been described above, the multiple roller pairs of the conveyance roller pairs 14 and 15 are preferably located so as not to overlap the liquid application position B1 on the sheet P in the main scanning direction, like the multiple roller pairs of the conveyance roller pair 11.

The liquid applier 131 applies liquid (for example, water) to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

FIGS. 28A and 28B are schematic views of the liquid applier 131 in the thickness direction of the sheet P, according to another embodiment of the present disclosure.

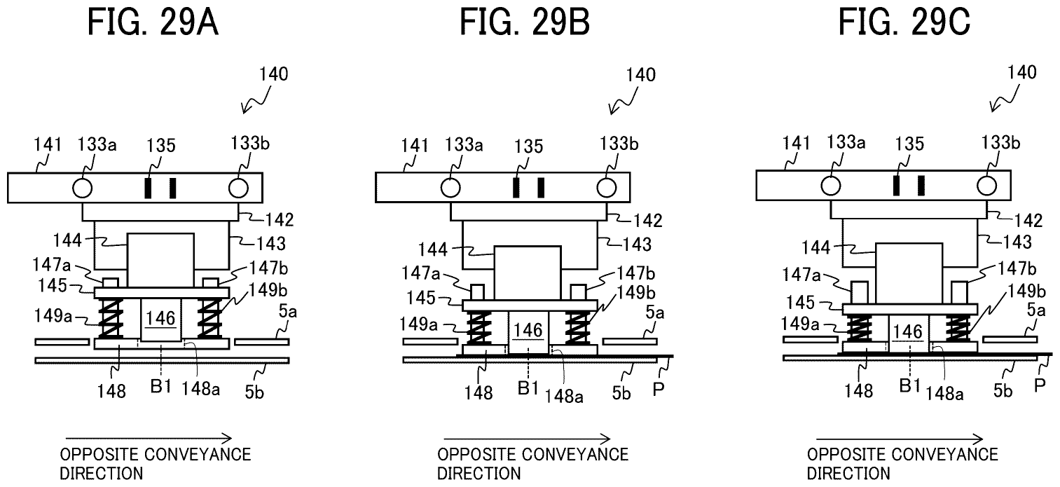

FIGS. 29A, 29B, and 29C are cross-sectional views of the liquid applier 131 taken along line XXV-XXV of FIG. 28A.

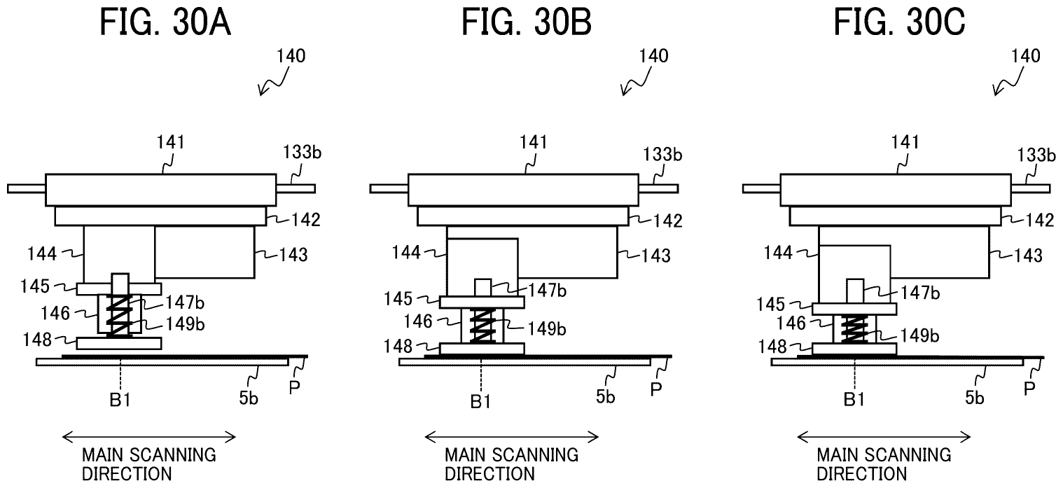

FIGS. 30A, 30B, and 30C are cross-sectional views of the liquid applier 131 taken along line XXVI-XXVI of FIG. 28A.

As illustrated in FIGS. 28A to 30C, the liquid applier 131 includes a pair of guide shafts 133a and 133b, a pair of pulleys 134a and 134b, endless annular belts 135 and 136, a liquid applier movement motor 137, a standby position sensor 138 (see FIG. 25), and a liquid application unit 140.

The guide shafts 133a and 133b, each extending in the main scanning direction, are spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the pair of guide shafts 133a and 133b in the opposite conveyance direction. The pulleys 134a and 134b are disposed away from each other in the main scanning direction. The pair of pulleys 134a and 134b are supported by a frame of the post-processing apparatus 3A so as to be rotatable about the rotation axis extending in the thickness direction of the sheet P.

The endless annular belt 135 is looped around the pair of pulleys 134a and 134b. The endless annular belt 135 is coupled to the liquid application unit 140 by a connection 135a. The endless annular belt 136 is looped around the pulley 134a and a driving pulley 137a that is fixed to an output shaft of the liquid applier movement motor 137. The liquid applier movement motor 137 generates a driving force to move the liquid application unit 140 in the main scanning direction.

As the liquid applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to switching of the rotation direction of the liquid applier movement motor 137.

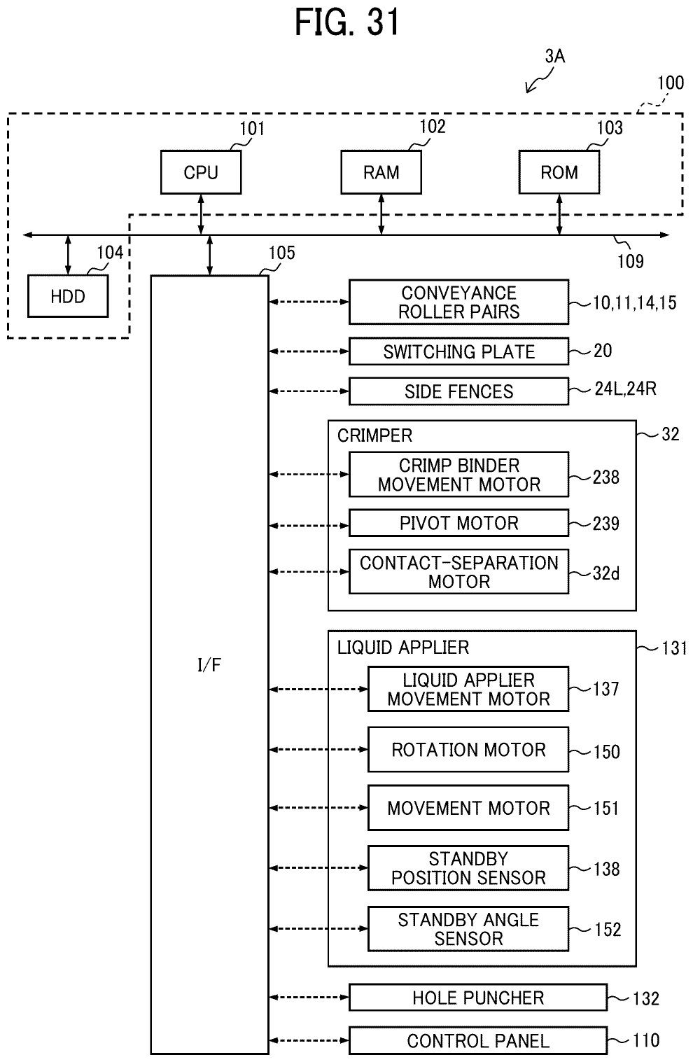

The standby position sensor 138 detects that the liquid application unit 140 has reached a standby position in the main scanning direction. The standby position sensor 138 then outputs a standby position signal indicating the detection result to the controller 100, which will be described below with reference to FIG. 31. The standby position sensor 138 is, for example, an optical sensor including a light emitter and a light receiver. The liquid application unit 140 at the standby position blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 292A to 29C, the conveyance path inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed to face the conveyance path (a position at which the liquid application unit 140 is to face the sheet P conveyed along the conveyance path) through the opening of the upper guide plate 5a.

As illustrated in FIGS. 28A to 30C, the liquid application unit 140 includes a base 141, a rotary bracket 142, a liquid storage tank 143, a mover 144, a holder 145, the liquid application head 146, columns 147a and 147b, a pressure plate 148, coil springs 149a and 149b, a rotary motor 150, a movement motor 151 illustrated in FIG. 31, and a standby angle sensor 152, which is also illustrated in FIG. 31.

The base 141 is supported by the pair of guide shafts 133a and 133b so as to be slidable in the main scanning direction. The base 141 is coupled to the endless annular belt 135 by the connection 135a. The base 141 supports the components of the liquid application unit 140 such as the rotary bracket 142, the liquid storage tank 143, the mover 144, the holder 145, the liquid application head 146, the columns 147a and 147b, the pressure plate 148, the coil springs 149a and 149b, the rotary motor 150, the movement motor 151, and the standby angle sensor 152.

The rotary bracket 142 is supported by a lower face of the base 141 so as to be pivotable about an axis extending in the thickness direction of the sheet P. The rotary bracket 142 is rotated with respect to the base 141 by a driving force transmitted from the rotary motor 150. The rotary bracket 142 supports the liquid storage tank 143, the mover 144, the holder 145, the liquid application head 146, the columns 147a and 147b, the pressure plate 148, and the coil springs 149a and 149b.

The standby angle sensor 152, which is also illustrated in FIG. 31, detects that the rotary bracket 142 has reached a standby angle. The standby angle sensor 152 then outputs a standby angle signal indicating the detection result to the controller 100. The standby angle is, for example, an angle for the parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 28A illustrates the rotary bracket 142 in a position for the parallel binding that is performed by the crimper 32 disposed downstream from the liquid applier 131 in a direction in which the sheet P is conveyed.

FIG. 28B illustrates the rotary bracket 142 in a position for the oblique binding (i.e., corner binding) that is performed by the crimper 32 disposed downstream from the liquid applier 131 in the direction in which the sheet P is conveyed.

The liquid storage tank 143 stores liquid to be applied to the sheet P. The mover 144 is supported by the liquid storage tank 143 so as to be movable (for example, up and down) in the thickness direction of the sheet P. The mover 144 is moved with respect to the liquid storage tank 143 by a driving force transmitted from the movement motor 151. The holder 145 is attached to a lower end of the mover 144. The liquid application head 146 projects from the holder 145 toward the conveyance path (downward in the present embodiment). The liquid that is stored in the liquid storage tank 143 is supplied to the liquid application head 146. The liquid application head 146 is made of a material having a relatively high liquid absorption (e.g., sponge or fiber).

The columns 147a and 147b project downward from the holder 145 around the liquid application head 146. The columns 147a and 147b can move relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 downward with respect to the holder 145.

As illustrated in FIGS. 29A and 30A, before the sheet P is conveyed to the position where the sheet P faces the opening of the upper guide plate 5a, the pressure plate 148 is positioned at or above the opening. When the sheet P that is conveyed by the conveyance roller pairs 10 and 11 stops at a position where the liquid application position B1 on the sheet P faces the opening, the movement motor 151 is rotated in a first direction. As a result, the mover 144, the holder 145, the liquid application head 146, the columns 147a and 147b, the pressure plate 148, and the coil springs 149a and 149b are moved down together to allow the pressure plate 148 to contact the sheet P. Note that the liquid application position B1 corresponds to the binding position to be crimped and bound by the edge binder 25.

As the movement motor 151 keeps rotating in the first direction after the pressure plate 148 contacts the sheet P, the coil springs 149a and 149b are compressed to further move down the mover 144, the holder 145, the liquid application head 146, and the columns 147a and 147b.

As a result, as illustrated in FIGS. 29B and 30B, a lower face of the liquid application head 146 contacts the sheet P through the through hole 148a. As a result, the liquid contained in the liquid application head 146 is applied to the sheet P.

Further, as illustrated in FIGS. 29C and 30C, the movement motor 151 is further rotated in the first direction. By so doing, the liquid application head 146 can be further strongly pressed against the sheet P. Accordingly, the amount of liquid that is applied to the sheet P increases. In other words, the liquid applier 131 changes the pressing force of the liquid application head 146 against the sheet P to adjust the amount of liquid that is applied to the sheet P.

On the other hand, the rotation of the movement motor 151 in a second direction opposite to the first direction moves up the mover 144, the holder 145, the liquid application head 146, the columns 147a and 147b, the pressure plate 148, and the coil springs 149a and 149b together. As a result, as illustrated in FIGS. 29A and 30A, the liquid application head 146 and the pressure plate 148 are separated from the sheet P. In other words, the liquid applier 131 includes the liquid application head 146 that can be separated from the sheet P.

FIG. 31 is a block diagram illustrating a control block hardware configuration of the post-processing apparatus 3A to control the operation of the post-processing apparatus 3A according to another embodiment of the present disclosure.

As illustrated in FIG. 31, the post-processing apparatus 3A includes the CPU 101, the RAM 102, the ROM 103, the HDD 104, and the I/F 105.

The CPU 101, the RAM 102, the ROM 103, the HDD 104, and the I/F 105 are connected to each other via the common bus 109.

The CPU 101 is an arithmetic unit and controls the overall operation of the post-processing apparatus 3A.

The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, and the HDD 104 construct the controller 100 that controls the operation of the post-processing apparatus 3A.

The I/F 105 is an interface that connects the conveyance roller pairs 10, 11, 14, and 15, the switching member 20, the side fences 24L and 24R, the crimper movement motor 238, the pivot motor 239, the contact-separation motor 32d, the liquid applier movement motor 137, the rotary motor 150, the movement motor 151, the standby position sensor 138, the standby angle sensor 152, the hole punch 132, and the control panel 110, to the common bus 109. The controller 100 controls operations of the conveyance roller pairs 10, 11, 14, and 15, the switching member 20, the side fences 24L and 24R, the crimper movement motor 238, the pivot motor 239, the contact-separation motor 32d, the liquid applier movement motor 137, the rotary motor 150, the movement motor 151, and the hole punch 132, through the I/F 105. On the other hand, the controller 100 acquires, via the I/F 105, detection results from the standby position sensor 138 and the standby angle sensor 152.

The control panel 110 includes an operation device that receives instructions input by an operator and a display serving as a notifier that notifies the operator of information. The operation device includes, for example, hard keys and a touch screen overlaid on the display. The control panel 110 acquires information from the user through the operation unit and provides the information to the user through the display.

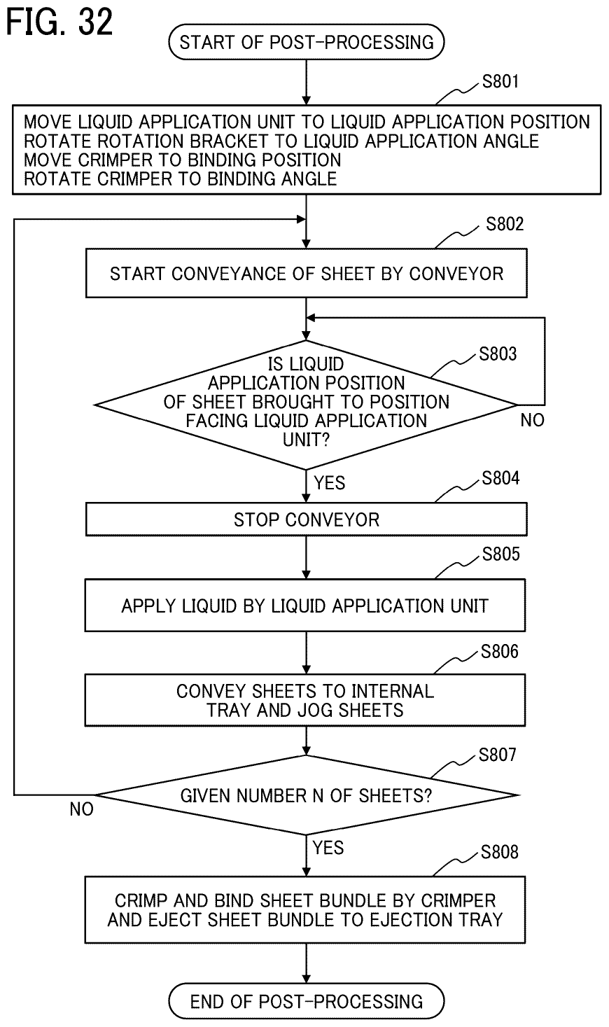

FIG. 32 is a flowchart of the post-processing process performed by the post-processing apparatus 3A according to another embodiment of the present disclosure. Specifically, FIG. 32 is a flowchart of a process to execute the one-point binding illustrated in FIGS. 26A, 26B and 26C.

For example, the controller 100 executes the post-processing process in the flowchart of FIG. 32 when the controller 100 acquires an instruction to execute the post-processing from the image forming apparatus 2. In the following description, the instruction to execute the post-processing may be referred to as a “post-processing command.” The post-processing command includes, for example, the number of sheets P of the sheet bundle Pb, the binding position B1 (corresponding to the liquid application position B1), a binding angle (corresponding to a liquid application angle), and a process that is executed in parallel with the liquid application process (i.e., punching a hole in the present embodiment). In the following description, the number of sheets P of the sheet bundle Pb may be referred to as a “given number N.” At the start of the post-processing, the liquid application unit 140 is at the standby position HP corresponding to the standby position HP illustrated in FIGS. 26A, 26B and 26C, and the rotary bracket 142 is held at the standby angle.

First, in step S801, the controller 100 drives the liquid applier movement motor 137 to move the liquid application unit 140 in the main scanning direction such that liquid application head 146 moves from the standby position HP to a position where the liquid application head 146 can face the liquid application position B1 corresponding to the binding position B1 illustrated in FIGS. 26A, 26B, and 26C. In addition, in step S801, the controller 100 drives the rotary motor 150 to rotate the rotary bracket 142 such that the liquid application head 146 rotates from the standby angle to the liquid application angle. It is ascertained based on a pulse signal output from a rotary encoder of the liquid applier movement motor 137 that the liquid application head 146 has reached the position where the liquid application head 146 can face the liquid application position B1. Similarly, it is ascertained based on a pulse signal output from a rotary encoder of the rotary motor 150 that the liquid application head 146 has reached the liquid application angle.

In step S801, the controller 100 drives the crimper movement motor 238 to move the crimper 32 from the standby position HP to the position where the crimper 32 can face the binding position B1, as illustrated in FIGS. 26A and 26B. Furthermore, in step S801, the controller 100 drives the pivot motor 239 to rotate the crimper 32 from the standby angle to the binding angle, which may be referred to as a crimp binding angle in the following description. It is ascertained based on a pulse signal output from a rotary encoder of the crimper movement motor 238 that the crimper 32 has reached the position where the crimper 32 can face the binding position B1. Similarly, it is ascertained based on a pulse signal output from a rotary encoder of the pivot motor 239 that the crimper 32 has reached the crimp binding angle.

Subsequently, in step S802, the controller 100 drives the conveyance roller pairs 10 and 11 to start conveying the sheet P on which an image is formed by the image forming apparatus 2. In step S803, the controller 100 determines whether the liquid application position B1 on the sheet P has faced the liquid application unit 140 (more specifically, the liquid application head 146). When the liquid application position B1 on the sheet P has not faced the liquid application head 146 (NO in step S803), the controller 100 repeats the determination in step S803. In other words, the controller 100 continues driving the conveyance roller pairs 10 and 11 until the liquid application position B1 on the sheet P faces the liquid application head 146.

In contrast, when the liquid application position B1 on the sheet P has faced the liquid application head 146 (YES in step S803), in step S804, the controller 100 stops the conveyance roller pairs 10 and 11.

It is ascertained, based on a pulse signal output from a rotary encoder of a motor that drives the conveyance roller pairs 10 and 11, that the liquid application position B1 on the sheet P has faced the liquid application head 146.

In step S805, the controller 100 causes the liquid applier 131 to execute the process to apply liquid to the liquid application position B1 on the sheet P. More specifically, the controller 100 rotates the movement motor 151 in the first direction to bring the liquid application head 146 into contact with the liquid application position B1 on the sheet P. In addition, the controller 100 changes the pressing force of the liquid application head 146 (in other words, the amount of rotation of the movement motor 151) depending on the amount of liquid that is applied to the sheet P.

The amount of liquid that is applied to the sheet P may be the same for all the sheets P of the sheet bundle Pb or may be different for each sheet P. For example, the controller 100 may apply a decreased amount of liquid to the sheet P conveyed later. The amount of rotation of the movement motor 151 may be ascertained based on a pulse signal output from a rotary encoder of the movement motor 151.

Subsequently, in step S806, the controller 100 drives the conveyance roller pairs 10, 11, 14, and 15 to place a sheet P on the internal tray 22. The controller 100 moves the side fences 24L and 24R to align the position of the sheet bundle Pb placed on the internal tray 22 in the main scanning direction. In short, the controller 100 performs so-called jogging.

Subsequently, in step S807, the controller 100 determines whether the number of sheets P placed on the internal tray 22 has reached the given number N of sheets indicated by the post-processing command. When the controller 100 determines that the number of sheets P placed on the internal tray 22 has not reached the given number N of sheets P (NO in step S807), the controller 100 executes the operations of steps S802 to S806 again.

In contrast, when the controller 100 determines that the number of sheets P placed on the internal tray 22 has reached the given number N of sheets P (YES in step S807), in step S808, the controller 100 causes the crimper 32 to crimp and bind the binding position B1 (corresponding to the liquid application position B1) on the sheet bundle Pb to which the liquid has been applied by the liquid applier 131. In addition, in step S808, the controller 100 rotates the conveyance roller pair 15 to eject the crimp-bound sheet bundle Pb to the ejection tray 26.

Then, the controller 100 drives the liquid applier movement motor 137 to move the liquid applier 131 to the standby position HP and drives the crimper movement motor 238 to move the crimper 32 to the standby position HP.

As described above, the control method by the controller 100 described above is implemented by cooperation between hardware resources of a computer and a program as computer software. In other words, the control method may be executed by causing an arithmetic device, a storage device, an input device, an output device, and a control device to operate in cooperation with each other based on a program. In addition, the program may be written in, for example, a storage device or a storage medium and distributed, or may be distributed through, for example, an electric communication line.

Embodiments of the present disclosure are not limited to the above-described embodiments, and numerous additional modifications and variations are possible in light of the teachings within the technical scope of the appended claims. It is therefore to be understood that the above-described embodiments of the present disclosure may be practiced otherwise by those skilled in the art than as specifically described herein. Such modifications are also included in the technical scope of the present disclosure.

### Aspects of the Present Disclosure

Aspects of the present disclosure are, for example, as follows.

### Aspect 1

In Aspect 1, a medium processing apparatus includes a liquid applier that applies liquid on a part of at least one medium, and a post-processing device that performs a process a media bundle including the at least one medium. The liquid applier includes a liquid application member, a liquid storage, a liquid application member movement mechanism, and a compression support. The liquid application member has a liquid application end portion that contacts the medium. The liquid storage is capable of storing liquid used for the liquid application. The liquid application member movement mechanism brings the liquid application member to approach or separates from the medium to contact or separate the liquid application end portion to or from the medium. The compression support compresses the liquid application member according to an approaching operation of the liquid application end portion to the medium by the liquid application member movement mechanism.

### Aspect 2

In Aspect 2, the medium processing apparatus according to Aspect 1 further includes a compression support movement mechanism that can move the compression support relative to the liquid storage. When a remaining amount of the liquid stored in the liquid storage is equal to or greater than a given amount, the compression support movement mechanism moves in a same direction as the liquid application member movement mechanism by a same amount as the liquid application member movement mechanism. When the remaining amount of the liquid stored in the liquid storage is less than the given amount, the compression support movement mechanism moves relative to a movement of the liquid application member movement mechanism.

### Aspect 3

In Aspect 3, the medium processing apparatus according to Aspect 2 further includes a coupling member that couples a movement of the compression support movement mechanism and a movement of the liquid application member movement mechanism. A drive source that applies a driving force for moving the liquid application member to the medium and a drive source that applies a driving force for moving the compression support function as a single drive source. When the remaining amount of the liquid stored in the liquid storage is less than the given amount, the coupling member couples the liquid application member movement mechanism and the compression support movement mechanism via the coupling member to have a difference between an amount of movement of the liquid application member movement mechanism and an amount of movement of the compression support movement mechanism.

### Aspect 4

In Aspect 4, the medium processing apparatus according to Aspect 2 further includes a transmission member that transmits a driving force applied by a driver that applies the driving force to move the compression support movement mechanism. The compression support is disposed surrounding the liquid application member, in other words, the compression support includes the liquid application member inside. The liquid applier further includes a valve member at a coupling portion of the transmission member and the compression support to prevent leakage of the liquid in the liquid application member from the coupling portion.

### Aspect 5

In Aspect 5, an image forming system includes an image forming apparatus that forms an image on the medium, and the medium processing apparatus according to any one of Aspects 1 to 4 that performs the process on the multiple media having the image formed by the image forming apparatus.

### Aspect 6

In Aspect 6, a medium processing apparatus includes a liquid applier and a post-processing device. The liquid applier applies liquid onto a medium. The post-processing device performs a process on a media bundle including the medium with the liquid applied by the liquid applier. The liquid applier includes a liquid application member, a liquid storage, a movement mechanism, and a compression support. The liquid application member has an end portion to contact with the medium to apply the liquid onto the medium. The liquid storage stores the liquid to be supplied to the liquid application member. The movement mechanism moves the liquid application member toward or away from the medium to bring the end portion into contact with the medium or separate the end portion from the medium as an approaching operation. The compression support compresses the liquid application member according to the approaching operation of the movement mechanism.

### Aspect 7

In Aspect 7, the medium processing apparatus according to Aspect 6 further includes another movement mechanism to move the compression support relative to the liquid application member. Said another movement mechanism moves in a same direction by a same amount as the movement mechanism when a remaining amount of the liquid stored in the liquid storage is equal to or greater than a given amount. Said another movement mechanism moves in the same direction by a different amount from the movement mechanism when the remaining amount of the liquid stored in the liquid storage is less than the given amount.

### Aspect 8

In Aspect 8, the medium processing apparatus according to Aspect 7 further includes a coupler to couple the movement mechanism with said another movement mechanism. The movement mechanism has a driver to apply a driving force to move the liquid application member to the media bundle, and apply a driving force to move the compression support to the media bundle as a driver of said another movement mechanism. The coupler decouples the driver of the movement mechanism with said another movement mechanism to cause a first amount of movement of the movement mechanism to be different from a second amount of movement of said another movement mechanism when the remaining amount of the liquid stored in the liquid storage is less than the given amount.

### Aspect 9

In Aspect 9, the medium processing apparatus according to Aspect 7 further includes a driver and a transmitter. The driver drives said another movement mechanism to move the compression support. The transmitter transmits a driving force of the driver to said another movement mechanism. The compression support holds the liquid application member inside the compression support. The liquid applier further includes a valve at a coupling portion coupling the transmitter and the compression support.

### Aspect 10

In Aspect 10, an image forming system includes an image forming apparatus to form an image on a medium, and the medium processing apparatus according to any one of Aspects 6 to 9 to perform the process on multiple media including the medium having the image formed by the image forming apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a liquid applier to apply liquid onto a medium; and
a post-processing device to perform a process on a media bundle including the medium with the liquid applied by the liquid applier,
wherein the liquid applier includes:
a liquid application member having an end portion to contact with the medium to apply the liquid onto the medium;
a liquid storage to store the liquid to be supplied to the liquid application member;
a movement mechanism to move the liquid application member toward or away from the medium to bring the end portion into contact with the medium or separate the end portion from the medium as an approaching operation; and
a compression support to compress the liquid application member according to the approaching operation of the movement mechanism.

2. The medium processing apparatus according to claim 1, further comprising another movement mechanism to move the compression support relative to the liquid application member,
wherein said another movement mechanism moves in a same direction by a same amount as the movement mechanism when a remaining amount of the liquid stored in the liquid storage is equal to or greater than a given amount, and
said another movement mechanism moves in the same direction by a different amount from the movement mechanism when the remaining amount of the liquid stored in the liquid storage is less than the given amount.

3. The medium processing apparatus according to claim 2, further comprising a coupler to couple the movement mechanism with said another movement mechanism,
wherein the movement mechanism has a driver to:
apply a driving force to move the liquid application member to the media bundle; and
apply a driving force to move the compression support to the media bundle as a driver of said another movement mechanism,
the coupler decouples the driver of the movement mechanism with said another movement mechanism to cause a first amount of movement of the movement mechanism to be different from a second amount of movement of said another movement mechanism when the remaining amount of the liquid stored in the liquid storage is less than the given amount.

4. The medium processing apparatus according to claim 2, further comprising:
a driver to drive said another movement mechanism to move the compression support; and
a transmitter to transmit a driving force of the driver to said another movement mechanism,
wherein the compression support holds the liquid application member inside the compression support, and
the liquid applier further includes a valve at a coupling portion coupling the transmitter and the compression support.

5. An image forming system comprising:
an image forming apparatus to form an image on a medium; and
the medium processing apparatus according to claim 1 to perform the process on multiple media including the medium having the image formed by the image forming apparatus.
